(19) United States
(12) Patent Application Publication
(10) Pub. No.: US 2025/0209705 A1
(43) Pub. Date: Jun. 26, 2025

(54) ONLINE INTERACTION METHOD AND APPARATUS, DEVICE, AND STORAGE MEDIUM

(71) Applicant: TENCENT TECHNOLOGY (SHENZHEN) COMPANY LIMITED, Shenzhen (CN)

(72) Inventors: Qingqing REN, Shenzhen (CN); Yitong Wang, Shenzhen (CN); Shuyuan Li, Shenzhen (CN); Chuanyu Zhang, Shenzhen (CN); Zirui Cheng, Shenzhen (CN); Jinchao Zeng, Shenzhen (CN); Yanhua Zhao, Shenzhen (CN); Silin Liu, Shenzhen (CN); Guiyi Yang, Shenzhen (CN); Tongyi Guo, Shenzhen (CN)

(73) Assignee: TENCHENT TECHNOLOGY (SHENZHEN) COMPANY LIMITED, Shenzhen (CN)

(21) Appl. No.: 19/077,763

(22) Filed: Mar. 12, 2025

Related U.S. Application Data
(63) Continuation of application No. PCT/CN2024/071144, filed on Jan. 8, 2024.

(30) Foreign Application Priority Data
Mar. 9, 2023 (CN) 202310264972.0

(51) Int. Cl. G06T 11/60; G06F 3/01

(52) U.S. Cl. CPC G06T 11/60; G06F 3/011

(57) ABSTRACT

An apparatus, computer-readable memory storing a program, and method providing online interaction including displaying an access entry to an online room; displaying, based on the access entry being triggered, a visual queue comprising a first account and at least one other account; displaying, based on the turn of the first account in a queue, a video picture of a mediator account in the online room; and displaying, based on an interaction operation, interaction information of interaction between the first account and the mediator account in the online room.

### CROSS-REFERENCE TO RELATED APPLICATIONS

This application is a continuation application of International Application No. PCT/CN2024/071144 filed on Jan. 8, 2024 which claims priority to Chinese Patent Application No. 202310264972.0, filed with the China National Intellectual Property Administration on Mar. 9, 2023, the disclosures of each being incorporated by reference herein in their entireties.

### FIELD

The disclosure relates to the field of Internet technologies, to the technical field of livestreaming, and to an online interaction method and apparatus, a device, and a storage medium.

### BACKGROUND

In the related art, livestreaming is an Internet service that develops relatively rapidly. In addition to performing talent show by using the livestreaming service, livestreaming types such as product release by manufacturers and product selling by idols using the livestreaming service are produced.

In a livestreaming process of a livestreamer user, the livestreamer user may transmit a live video stream to a viewer user. In a process in which the viewer user views the live video stream, the viewer user may transmit real-time subtitles and gifts to the livestreamer user for interaction.

However, in the livestreaming process, a large number of viewer users may simultaneously interact with the livestreamer user, resulting in poor interaction quality. Consequently, hardware resources supporting the livestreaming service are not effectively used.

### SUMMARY

Provided are an online interaction method and apparatus, a device, a storage medium, and a program product, which facilitate efficient user interactions in an online room environment by implementing visual queuing mechanisms and interactive displays. These embodiments enable improve user engagement, interaction quality, and resource utilization in online environments.

Some embodiments provide an online interaction method, performed by a computer device, a first account being logged into on the computer device, the method comprising: displaying an access entry to an online room; displaying, after based on the access entry being triggered, a visual queue comprising a first account and at least one other account in which at least two accounts are queued, the at least two accounts comprising the first account and any another account other than the first account; displaying, in based on the turn of the first account after queuing in a queue, a video picture of a mediator account in the online room; and displaying, in response based on an interaction operation, interaction information of interaction between the first account and the mediator account in the online room.

Some embodiments provide an online interaction apparatus, comprising: at least one memory configured to store program code; and at least one processor configured to read the program code and operate as instructed by the program code, the program code comprising: room code configured to cause at least one of the at least one processor to display an access entry to an online room; queuing code configured to cause at least one of the at least one processor to display, based on the access entry being triggered, a visual queue comprising a first account and at least one other account; displaying code configured to cause at least one of the at least one processor to display, based on the turn of the first account in a queue, a video picture of a mediator account in the online room; and interaction code configured to cause at least one of the at least one processor to display, based on an interaction operation, interaction information of interaction between the first account and the mediator account in the online room.

Some embodiments provide a non-transitory computer-readable storage medium, storing computer code which, when executed by at least one processor, causes the at least one processor to at least: display an access entry to an online room; display, based on the access entry being triggered, a visual queue comprising a first account and at least one other account; display, based on the turn of the first account in a queue, a video picture of a mediator account in the online room; and display, based on an interaction operation, interaction information of interaction between the first account and the mediator account in the online room.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a block diagram of an online interaction system according to some embodiments.

FIG. 2 is an interface interaction diagram of an online interaction method according to some embodiments.

FIG. 3 is an interface interaction diagram of an online interaction method according to some embodiments.

FIG. 4 is a schematic flowchart of an online interaction method according to some embodiments.

FIG. 5 is a schematic flowchart of an online interaction method according to some embodiments.

FIG. 6 is a schematic diagram of an online interaction method according to some embodiments.

FIG. 7A, FIG. 7B, FIG. 7C, FIG. 7D, FIG. 7E, FIG. 7F, and FIG. 7G are schematic interface diagrams of an online kick-off red packet giving meeting according to some embodiments, separately.

FIG. 8 is a schematic flowchart of an online interaction method according to some embodiments.

FIG. 9A, FIG. 9B, FIG. 9C, FIG. 9D, FIG. 9E, FIG. 9F, and FIG. 9G are schematic interface diagrams of an online idol signing session according to some embodiments, separately.

FIG. 10 is a flowchart of a meeting creation method according to some embodiments.

FIG. 11 is a schematic diagram of a meeting attendance method according to some embodiments.

FIG. 12 is an information flow diagram of an online interaction method according to some embodiments.

FIG. 13 is a structural block diagram of an online interaction apparatus according to some embodiments.

FIG. 14 is a structural block diagram of a computer device according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

“Several” mentioned in the specification means one or more, and “plurality of” means two or more. “And/or” describes an association relationship for describing associated objects and represents that three relationships may exist. For example, A and/or B may represent the following three cases: only A exists, both A and B exist, and only B exists. The character “/” in this specification generally indicates an “or” relationship between the associated objects.

Some embodiments may be based on a cloud meeting. The cloud meeting is a highly efficient, convenient, and low-cost meeting form based on a cloud computing technology. A user can rapidly and efficiently share a voice, a data file, and a video with teams and clients around the globe provided that the user performs a simple and easy operation through an Internet interface. A cloud meeting service provider assists the user in operating complex technologies such as data transmission and processing in a meeting.

Currently, domestic cloud meetings mainly focus on service content based on a software as a service (SaaS) mode, including service forms such as telephone, network, and video. A video meeting based on cloud computing is referred to as the cloud meeting.

In the era of the cloud meeting, data transmission, processing, and storage are all processed by computer resources of a video meeting manufacturer, and a user can conduct an efficient remote meeting only by opening a browser and logging in to a corresponding interface without purchasing expensive hardware and installing complex software.

A cloud meeting system supports multi-server dynamic cluster deployment, and provides a plurality of high-performance servers, thereby greatly improving meeting stability, security, and availability. In recent years, a video meeting has gained popularity among many users because of dramatically improving communication efficiency, continuously reducing communication costs, and upgrading internal management levels, and has been widely applied to various fields such as traffic, transportation, finance, operators, education, and enterprises. There is no doubt that after cloud computing is applied to the video meeting, the video meeting is more attractive in terms of convenience, quickness, and ease of use, and a video meeting application may be encouraged to arrive at a new climate.

Cloud social is a virtual social application mode of interaction applications of Internet of Things, cloud computing, and mobile Internet, and aims to establish a famous “resource sharing relationship graph”, to develop social networking. A main feature of cloud social is to uniformly integrate and evaluate a large quantity of social resources, to form an effective resource pool to provide services to users on demand. A larger quantity of users participating in sharing indicates a larger utilization value that can be created.

FIG. 1 shows a structural block diagram of a computer system according to some embodiments. The computer system 100 includes: a first device 120, a server 140, and a second device 160.

A first online room client supporting an online meeting and/or online livestreaming is installed and run on the first device 120. A first account (for example, a viewer account) is logged into on the first online room client. The first online room client may be configured to at least implement at least one of an online meeting or online livestreaming. Using an example in which a first user logs in to the first account, the first online room client is a platform used by a plurality of accounts including the first account to share multimedia content. The first device 120 is a device used by the first user. The first user may implement at least one of an online meeting or online livestreaming with another user logging in to different accounts by using the first online room client installed and run on the first device 120.

A second online room client supporting an online meeting and/or online livestreaming is installed and run on the second device 160. A second account (for example, a mediator account) is logged into on the second online room client. The second online room client may be configured to at least implement at least one of an online meeting or online livestreaming. Using an example in which a second user logs in to the second account, the second online room client is a platform used by a plurality of accounts including the second account to share multimedia content. The second device 160 is a device used by the second user. The second user may implement at least one of an online meeting or online livestreaming with another user logging in to different accounts by using the second online room client installed and run on the second device 160.

The first online room client and the second online room client may be specific implementations of a same platform on different devices. This is not limited.

The first device 120 and the second device 160 are connected to the server 140 via a wireless network or a wired network.

The server 140 includes at least one of one server, a plurality of servers, a cloud computing platform, or a virtualization center. For example, the server 140 includes a processor 144 and a memory 142. The memory 142 further includes a receiving module 1421, a processing module 1422, and a transmitting module 1423. The receiving module 1421 is configured to receive a message transmitted by an online room client. The processing module 1422 is configured to perform related processing according to the message. The transmitting module 1423 is configured to transmit a response to the online room client. The server 140 is configured to provide a background service for the online room client. In some embodiments, the server 140 is responsible for primary computing work, and the first device 120 and the second device 160 are responsible for secondary computing work. Alternatively, the server 140 is responsible for secondary computing work, and the first device 120 and the second device 160 are responsible for primary computing work. Alternatively, the server 140, the first device 120, and the second device 160 are responsible for computing work in a coordinated mode.

In some embodiments, the first online room client and the second online room client are a same online room client or different online room clients on different operating system platforms (Android or IOS). In some embodiments, device types of the first device 120 and the second device 160 are the same or different. The device types include: at least one of a smartphone, a smart watch, an in-vehicle device, a wearable device, a smart television, a tablet computer, an e-book reader, an MP3 player, an MP4 player, a laptop portable computer, or a desktop computer. In the following embodiments, for example, the device type includes a smartphone.

There may be more or fewer devices. For example, there may be only one device, or there may be dozens of or hundreds of or more devices. The quantity and the device type of the device are not limited herein.

The server 140 may be an independent physical server, or may be a server cluster or a distributed system formed by a plurality of physical servers, or may be a cloud server that provides cloud computing services such as a cloud service, a cloud database, cloud computing, a cloud function, cloud storage, a network service, cloud communication, a middleware service, a domain name service, a security service, a content delivery network (CDN), big data, and an AI platform.

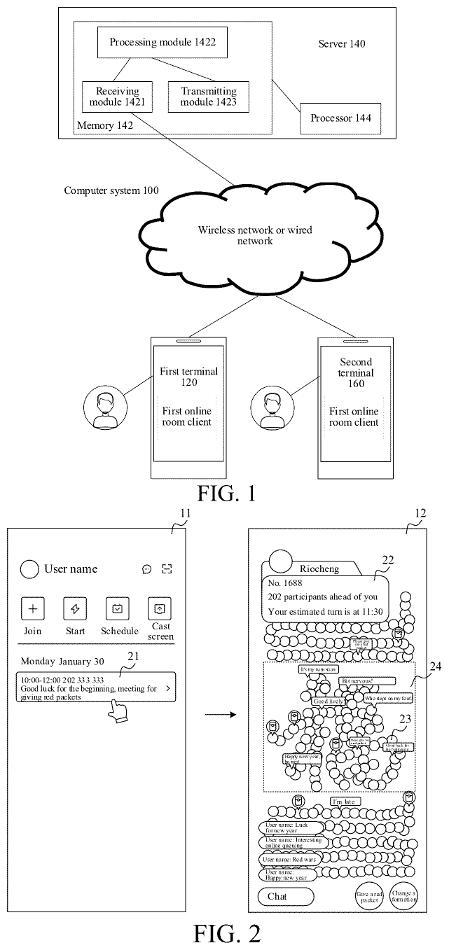

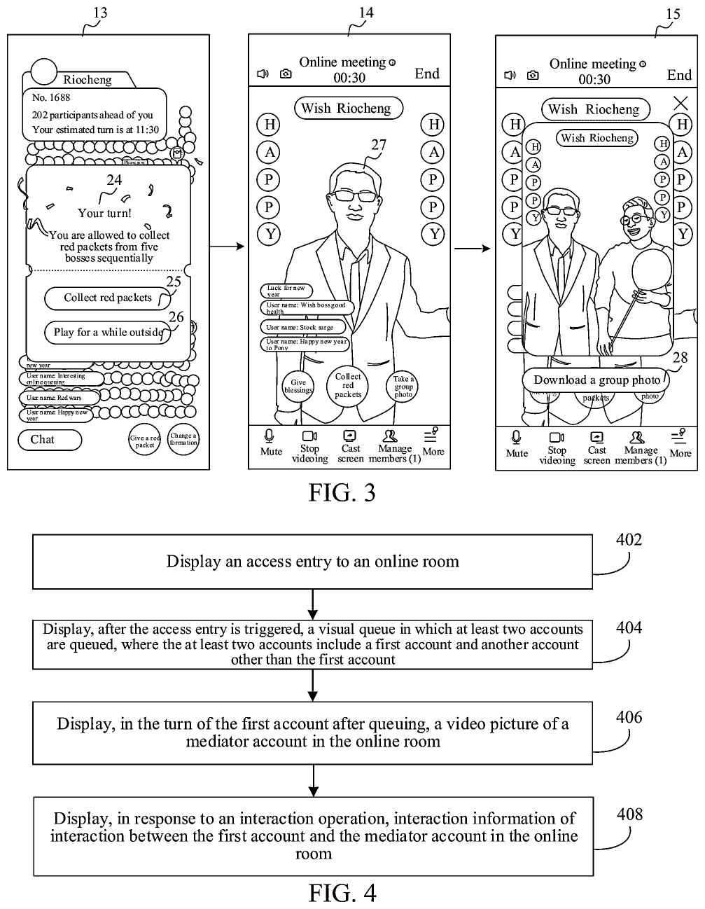

FIG. 2 and FIG. 3 show schematic interaction diagrams of an online room interaction method according to some embodiments. The interaction method includes: a queuing stage shown in FIG. 2 and an interaction stage shown in FIG. 3.

### Queuing Stage

Using an online meeting as an example, after a user logs in to a first online meeting client by using a first account, the first online meeting client displays an entry page 11 of an online meeting. A meeting entry 21 of the online meeting is displayed on the entry page 11. Information such as a meeting number, a meeting theme, and a meeting time is displayed on the access entry 21. After the user clicks/taps the access entry 21, the online meeting is entered. The online meeting is provided with an interaction hall and a livestreaming room corresponding to each mediator. The interaction hall may be considered as a waiting area or a waiting space independent of each livestreaming room.

The first online meeting client displays an interaction hall 12 of the online meeting. In some embodiments, an exclusive number card 22 of the first account is displayed on the interaction hall 12. The exclusive number card 22 is configured for indicating a queuing number or a queuing sequence of the first account. In some embodiments, the interaction hall 12 further displays avatars 23 of the first account and another account, and these avatars 23 are queued in a queuing formation in a text form or a pattern form according to an ascending sequence of queuing numbers. In English, the text format may be “Wish”, “Merry Christmas”, “Happy”, “Good Luck”, and the like. The pattern form may be a “heart”, a “building”, a “company brand”, or the like. In FIG. 2, a Chinese character 24 is formed by some avatars 23 according to an ascending sequence of queuing numbers. The Chinese character 24 may express meanings of blessings in Chinese.

Multiple interaction forms may be provided between the waiting accounts in the interaction hall 12. The multiple interaction forms include: at least one of clicking/tapping to switch a queuing formation, clicking/tapping to collect/give a red packet, clicking/tapping to transmit a real-time chat bullet screen, or clicking/tapping to perform atmosphere expression interaction.

### Interaction Stage

In the turn of the first account after queuing, the first online meeting client displays a queuing prompt page 13. The queuing prompt page 13 includes: at least one of prompt information 24 indicating the turn of the first account after queuing, an entry button 25 for interacting with the mediator account, or an exit button 26 for returning to the interaction hall 12.

If the user clicks/taps the entry button 25, the mediator account 27 sequentially performs exclusive interaction with all accounts in a visual queue according to the queuing numbers. The exclusive interaction includes: giving a red packet, group photo, voice conversation, video conversation, giving welfare, and the like. In some embodiments, the interaction is an exclusive interaction between the mediator account and the first account, and is invisible to another account. In some embodiments, a duration of the exclusive interaction between the mediator account and each queuing account in the visual queue is a fixed duration or a user-defined duration.

In an interaction interface 14 for the exclusive interaction, the mediator account 27 may give a virtual resource such as an electronic red packet, a virtual album, a virtual MV, or a virtual digital collection to the first account, and the first account collects or gives the virtual resource.

The first account may perform an electronic group photo with the mediator account 27, and a user image of the first account and a user image of the mediator account 27 are stitched to generate the electronic group photo. Then, a group photo download button 28 is clicked/tapped to download the group photo.

On an end interface 15 in which the exclusive interaction ends, the first account may further click/tap to replay, click/tap to save a group photo, click/tap to jump to a livestreaming room of another mediator, click/tap to jump to an advertisement detail page, or click/tap to forward to a social platform for sharing.

FIG. 4 shows a schematic interaction diagram of an online room interaction method according to some embodiments. The method may be performed by a computer device. A first account is logged into on the computer device. The method includes the following operations.

Operation 402: Display an access entry to an online room.

The online room is a virtual room in which at least two users are located on a network. The online room may, in some embodiments, be referred to as a channel, a meeting, a livestreaming room, or another name. In some embodiments, the online room is an online meeting room or an online livestreaming room.

The first account is an account of a specific user. The specific user may be referred to as a first user. The first account enters the online room through the access entry. The access entry includes: a button, an icon, a graphic code, an invitation link, or the like. The graphic code is a graph. The graph is obtained by encoding some information, and the encoded information may be restored by decoding the graphic code. The graphic code may be a two-dimensional code or a one-dimensional bar code. The invitation link may be in a format of a uniform resource locator (URL), or may be an instant message encapsulated in a specific format.

Operation 404: Display, after the access entry is triggered, a visual queue in which at least two accounts are queued, where the at least two accounts include the first account and any another account other than the first account.

After the access entry is triggered, a visual queue in which the first account and at least one other account are queued, where the first account and the at least one other account form at least two accounts. The at least one other account is an account of another user entering the online room, i.e. any another account other than the first account, and may be an account of a user other than the first user.

In some embodiments, after the access entry is triggered, the first account enters an online room, and a visual queue in which at least two accounts are queued is displayed in the online room, where the at least two accounts include the first account and any another account other than the first account. However, it is not excluded that in some embodiments, after the access entry is triggered, the first account does not enter an online room, and a visual queue in which the first account and at least one account are queued is displayed outside the online room.

In some embodiments, the visual queue is sorted based on queuing numbers of accounts. In some embodiments, the at least one other account includes only an account that enters the room before the first account, or the at least one other account includes only an account that enters the room after the first account, or the at least one other account includes both an account that enters the room before the first account and an account that enters the room after the first account.

In some embodiments, the queuing numbers of the accounts are generated according to a chronological order of triggering the access entry by the accounts, according to a chronological order of the accounts entering the online room, according to work numbers of the accounts in an organization, or according to random numbers extracted from the accounts. A mode of generating a queuing number of each account is not limited.

In some embodiments, the visual queue is arranged according to a queuing formation. The queuing formation may be in at least one of a text form and/or a pattern form. The text form may be a text form in Chinese, English, or another language. For example, the text form may be a text that expresses meanings such as blessings, festivals, and celebrations, and the text may be Chinese or English. In English, the text format may be “Wish”, “Merry Christmas”, “Happy”, “Good Luck”, and the like. The pattern form is a non-literal graph, and may be, for example, a heart, a building, or a company brand.

In some embodiments, the visual queue is a visual queue for queuing to perform a one-to-one exclusive interaction with a mediator account. In some embodiments, the visual queue is a visual queue for queuing to perform an n-to-one exclusive interaction with a mediator account. The n accounts may be a fixed value and may be a positive integer greater than 1. The n accounts may be account groups or account sets obtained by division according to groups, subsidiaries, subgroups, friends, and the like. If the n-to-one exclusive interaction includes both a one-to-one exclusive interaction and a many-to-one exclusive interaction, n may be a positive integer.

In some embodiments, after the access entry is triggered, the computer device may display a visual queue in which at least two visual elements are queued, where the at least two visual elements are in a one-to-one correspondence with at least two accounts. The visual element includes at least one of an avatar, a virtual image, a cartoon character, or the like.

In some embodiments, after the access entry is triggered, the computer device may display a visual queue in which at least two visual elements are queued according to a first queuing formation. The at least two visual elements include a first visual element and at least one other visual element other than the first visual element. The first visual element corresponds to the first account. The at least one other visual element is in one-to-one correspondence with the at least one other account.

In some embodiments, at least one interaction control is displayed in the queuing process. The interaction control is configured for providing at least one of interaction functions such as a real-time interaction bullet screen between the first account and another account, collecting a virtual resource, entering an interaction emoji, connecting a microphone, and performing a group photo, a voice conversation, and a video conversation.

In some embodiments, another account refers to any another account other than the first account and the mediator account.

Operation 406: Display, in the turn of the first account after queuing, a video picture of a mediator account in the online room.

When the online room is an online meeting room, the mediator account may be an account of a meeting mediator. When the online room is an online livestreaming room, the mediator account may be an account of a livestreamer user.

The turn of the first account after queuing means the turn of the first account performing a one-to-one exclusive interaction with the mediator account according to the queuing sequence. In the turn of the first account after queuing, another account ranked ahead the first account has completely interacted with the mediator account.

In the turn of the first account after queuing, an online video picture or an online audio picture of the mediator account in the online room is displayed. In some embodiments, the video picture of the mediator account is generated based on a livestreaming data stream or a meeting data stream of the mediator account.

In some embodiments, at least one interaction control is displayed on the video picture of the mediator account. The interaction control is configured for providing at least one of interaction functions such as a real-time interaction bullet screen between the first account and the mediator account, collecting a virtual resource, entering an interaction emoji, connecting a microphone, and performing a group photo, a voice conversation, and a video conversation.

Operation 408: Display, in response to an interaction operation, interaction information of interaction between the first account and the mediator account in the online room.

The interaction information of interaction between the first account and the mediator account in the online room is displayed in response to an interaction operation of triggering the interaction control by the user. The interaction information may be information representing an interaction process, or may be information generated through interaction.

In conclusion, according to the method provided in this embodiment, a visual queue in which at least two accounts are queued is displayed in an online room. The at least two accounts include a first account and any another account other than the first account. Interaction information of interaction between the first account and a mediator account in the online room is displayed in response to an interaction operation, thereby providing a queuing function in the online room. Therefore, in a case that there are many viewer users, an offline scenario of queuing for interaction can be simulated, such as an enterprise annual meeting, a kick-off red packet giving meeting, or an idol signing session. In addition, for the first account, an interaction function of exclusively interacting with the mediator account is provided, to block interference of another account, improve interaction quality of interaction between each queued account and the mediator account, and avoid a waste of hardware resources supporting an online room function caused by low-quality interaction.

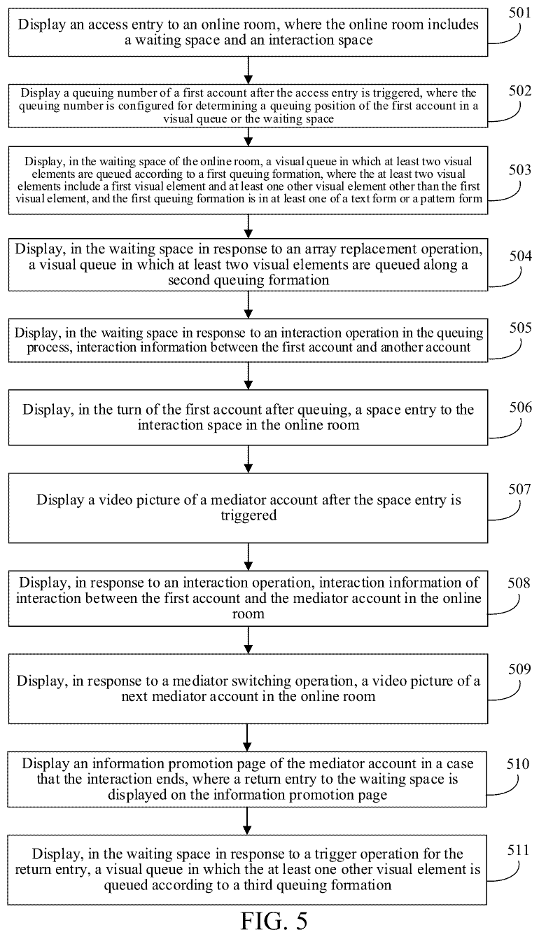

FIG. 5 shows a schematic interaction diagram of an online room interaction method according to some embodiments. The method may be performed by a computer device. A first account is logged into on the computer device. The method includes the following operations.

Operation 501: Display an access entry to an online room, where the online room includes a waiting space and an interaction space.

The online room is a virtual room in which at least two users are located. In some embodiments, the online room is an online meeting or an online livestreaming room.

The first account enters the online room through the access entry. The access entry includes: a graphic code, an invitation link, and the like. The access entry may be pushed directionally, extracted randomly, or collected by performing a task.

In some embodiments, the online room includes: a waiting space and at least one interaction space. The waiting space is space waiting to perform an exclusive interaction with a mediator account. The interaction space is space in which the mediator account performs an exclusive interaction with the accounts. The interaction space is provided by the mediator account, or the interaction space corresponds to the mediator account. Each mediator account corresponds to one interaction space, and one interaction space corresponds to one or more mediator accounts. In some embodiments, the interaction spaces corresponding to the mediator accounts are different from each other, or at least one mediator account corresponding to each interaction control is different from each other.

Each account in a queued state is located in the waiting space. One or n accounts in the round of the first account after queuing are located in the interaction space. After the exclusive interaction ends, each account may return from the interaction space to the waiting space.

Operation 502: Display a queuing number of a first account after the access entry is triggered, where the queuing number is configured for determining a queuing position of the first account in a visual queue or the waiting space.

In some embodiments, the queuing numbers of the accounts are generated according to a chronological order of triggering or obtaining the access entry by the accounts, according to a chronological order of the accounts entering the online room, according to work numbers of the accounts in an organization, or according to random numbers extracted from the accounts. A mode of generating a queuing number of each account is not limited.

In some embodiments, after the access entry is triggered, the queuing number of the first account and a space entry to the waiting space are displayed. When the user triggers the space entry to the waiting space, the first account enters the waiting space.

In some embodiments, after the access entry is triggered, the first account enters the waiting space, and the queuing number of the first account is displayed in the waiting space. The queuing number may be displayed all the time, or may be automatically canceled after being displayed for several seconds, or may be manually canceled by the user after being displayed.

In some embodiments, the queuing number of the first account is displayed, the queuing number of the first account is canceled after being displayed for several seconds, and the waiting space is automatically entered.

Operation 503: Display, in the waiting space of the online room, a visual queue in which at least two visual elements are queued according to a first queuing formation, where the at least two visual elements include a first visual element and at least one other visual element other than the first visual element, and the first queuing formation is in at least one of a text form or a pattern form.

In some embodiments, the first account enters the waiting space of the online room. The computer device represents an account by using a visual element in the waiting space, and displays a visual queue in which at least two visual elements are queued. The at least two visual elements include a first visual element and at least one other visual element other than the first visual element. The at least two visual elements are in a one-to-one correspondence with the at least two accounts. To be specific, the first visual element is in a one-to-one correspondence with the first account, and the at least one other visual element is in a one-to-one correspondence with at least one other account. The visual element includes at least one of an avatar, a virtual image, a cartoon character, or the like.

In some embodiments, the waiting space is displayed with at least one of a background image or a decorative accessory. The background image and the decorative accessory may be self-defined or configured by a creator of the online room.

In some embodiments, the visual queue is sorted based on queuing numbers of accounts.

In some embodiments, the visual queue is displayed according to a queuing formation. The queuing formation may be in at least one of a text form and/or a pattern form. The text form may be a text form in Chinese, English, or another language. For example, the text form may be a text that expresses meanings such as blessings, festivals, and celebrations, and the text may be Chinese or English. In English, the text format may be “Wish”, “Merry Christmas”, “Happy”, “Good Luck”, and the like. The pattern form is a non-literal graph, and may be, for example, a heart, a building, or a company brand. For example, by default, the visual queue is displayed according to the first queuing formation.

In some embodiments, the visual queue is configured for queuing to interact with the mediator account in the interaction space. In some embodiments, the visual queue is configured for queuing to perform a one-to-one exclusive interaction with the mediator account. In some embodiments, the visual queue is configured for queuing to perform an n-to-one exclusive interaction with the mediator account. The n accounts may be a fixed value and may be a positive integer greater than 1. The n accounts may be account groups or account sets obtained by division according to groups, subsidiaries, subgroups, friends, and the like. If the n-to-one exclusive interaction includes both a one-to-one exclusive interaction and a many-to-one exclusive interaction, n may be a positive integer.

Operation 504: Display, in the waiting space in response to an array replacement operation, a visual queue in which at least two visual elements are queued along a second queuing formation.

The first queuing formation is different from the second queuing formation.

In some embodiments, a plurality of queuing formations are pre-configured. In response to an array replacement operation triggered by the first account, a visual queue in which the first visual element and at least one other visual element are queued according to a second queuing formation is displayed in the waiting space. The second queuing formation is one of the plurality of queuing formations that is located behind the first queuing formation, or the second queuing formation is randomly selected from the plurality of queuing formations.

In some embodiments, replacement of the queuing formation does not need to be triggered by the user. The first queuing formation is automatically switched to the second queuing formation according to a fixed duration, or the first queuing formation is automatically switched to the second queuing formation according to a current quantity of queued persons. For example, each time the quantity of queued persons increases by 100, the first queuing formation is switched to the second queuing formation.

Operation 505: Display, in the waiting space in response to an interaction operation in the queuing process, interaction information between the first account and another account.

The waiting space provides multiple interaction functions between the first account and at least one other account. The interaction function includes at least one of a real-time interaction bullet screen between the first account and another account, collecting a virtual resource, entering an interaction emoji, connecting a microphone, and performing a group photo, a voice conversation, and a video conversation.

In some embodiments, in response to an operation of giving a first virtual resource, a collection entry to the first virtual resource given by the first account is displayed by using the first visual element as an anchor. The first virtual resource may be an electronic red packet, a bonus point, a virtual gift, or the like. The anchor is configured for indicating a display position. The displaying by using the first visual element as an anchor may be understood as: displaying by using the first visual element as a reference position, or displaying by surrounding the first visual element.

In some embodiments, a collection entry to a second virtual resource given by a second account is displayed by using a second visual element as an anchor, where the second visual element belongs to the at least one other visual element, the second visual element corresponds to the second account, and the second account belongs to the at least one other account. In response to an operation of collecting the second virtual resource, a collection result of the first account for the second virtual resource is displayed.

In some embodiments, in response to a messaging operation, a first message transmitted by the first account is displayed by using the first visual element as an anchor.

In some embodiments, in response to receiving a second message transmitted by a second account, the second message transmitted by the second account is displayed by using a second visual element as an anchor, where the second visual element belongs to the at least one other visual element, and the second visual element corresponds to the second account.

In some embodiments, in response to an emoji-entering operation, an emoji is displayed by using the first visual element as an anchor, or the emoji is displayed by using the first visual element as a carrier, or the emoji is displayed by using the waiting space as a carrier. The emoji is at least one of a text emoji, a picture emoji, an animated emoji, a dynamic emoji based on a three-dimensional virtual image, or an atmosphere emoji.

The displaying the emoji by using the first visual element as a carrier may be understood as: displaying, in a case that the first visual element is a two-dimensional virtual image, the emoji by using the two-dimensional virtual image; and displaying, in a case that the first visual element is a three-dimensional virtual image, the emoji by using the three-dimensional virtual image.

In some embodiments, in a case that an interaction index between the first account and another account meets a queue jumping condition, the queuing position of the first visual element in the visual queue is adjusted to a front queuing position than the current queuing position. The front queuing position may be determined based on the interaction index of the first account. The interaction index is determined based on at least one of a quantity of messages transmitted by the first account, a quantity of comments, a quantity of replies, a quantity of emojis entered, a quantity of virtual resources transmitted, or a quantity of virtual resources collected.

The foregoing interaction modes may be combined with each other or implemented separately. This is not limited in this embodiment.

Operation 506: Display, in the turn of the first account after queuing, a space entry to the interaction space in the online room.

The turn of the first account after queuing means the turn of the first account performing a one-to-one exclusive interaction with the mediator account according to the queuing sequence. In some embodiments, in the turn of the first account after queuing, another account ranked ahead the first account has completely interacted with the mediator account.

In the turn of the first account after queuing, the space entry to the interaction space in the online room is displayed. Alternatively, the waiting space in the online room is switched to the space entry to the interaction space. Alternatively, the interaction hall of the online room is switched to the space entry to the interaction space.

In some embodiments, when the first account becomes a head account in the visual queue, the turn of the first account after queuing is determined.

In some embodiments, there are n mediator accounts. When the first account becomes the head account in the visual queue, the turn of the first account after queuing relative to the n mediator accounts is determined, and the first account interacts with each mediator account sequentially. n is a positive integer greater than 1.

In some embodiments, there are n mediator accounts, and each mediator account has a corresponding team position in the visual queue. Different mediator accounts correspond to different team positions. When the first account is queued to the team position corresponding to an i^{th} mediator account in the visual queue, the turn of the first account after queuing relative to the i^{th} mediator account is considered. Both i and n are positive integers, and i is not greater than n.

Operation 507: Display a video picture of a mediator account after the space entry is triggered.

After the space entry is triggered, the first account enters the interaction space corresponding to the mediator account from the waiting space, and displays the video picture of the mediator account.

Operation 508: Display, in response to an interaction operation, interaction information of interaction between the first account and the mediator account in the online room.

In some embodiments, at least one interaction control is displayed on the video picture of the mediator account. The interaction control is configured for providing at least one of interaction functions such as a real-time interaction bullet screen, collecting a virtual resource, entering an interaction emoji, connecting a microphone, and performing a group photo, a voice conversation, or a video conversation.

The interaction information of interaction between the first account and the mediator account in the online room is displayed in response to an interaction operation of triggering the interaction control by the user.

The exclusive interaction includes: giving a red packet, group photo, voice conversation, video conversation, giving welfare, or the like. The interaction is an exclusive interaction between the mediator account and the first account. In some embodiments, a duration of the exclusive interaction between the mediator account and each queuing account in the visual queue is a fixed duration or a user-defined duration.

In some embodiments, at least one of a first message, a mediator message, or a third message is displayed in a bullet-screen form in the interaction space. The first message is a message transmitted by the first account in the interaction space, the mediator message is a message transmitted by the mediator account in the interaction space, and the third message is a message transmitted by the at least one other account in the waiting space.

In the interaction process of the exclusive interaction, the mediator account may give a virtual resource such as an electronic red packet, a virtual album, a virtual MV, or a virtual digital collection to the first account, and the first account collects or gives the virtual resource.

In some embodiments, in response to a first interaction operation, interaction information that the first account collects a virtual resource transmitted by the mediator account is displayed. The virtual resource includes at least one of an electronic red packet, an audio/video, a digital collection, a bonus point, or a coupon.

In some embodiments, in response to a second interaction operation, interaction information that the first account takes a group photo with the mediator account is displayed. In some embodiments, interaction information obtained after an image material of the first account and an image material of the mediator account are stitched according to a group photo template is displayed. The image materials are photographed in real time or user-defined and uploaded.

In some embodiments, the interaction information between the first account and the mediator account in the interaction space is invisible to another account located in the waiting space.

After the first account completes interaction with a current mediator, the first account may download, replay, and store interaction information between the first account and the current mediator.

Operation 509: Display, in response to a mediator switching operation, a video picture of a next mediator account in the online room.

If a plurality of mediator accounts exist and a current mediator is not the last, after the first account completes interaction with the current mediator, an interaction space of the current mediator is switched into an interaction space of a next mediator account.

In some embodiments, after interaction with the current mediator is completed, a switching button is displayed. In response to the switching button being clicked/tapped, the interaction space of the current mediator is switched into the interaction space of the next mediator account, and a video picture of the next mediator account in the online room is displayed.

Operation 510: Display an information promotion page of the mediator account in a case that the interaction ends, where a return entry to the waiting space is displayed on the information promotion page.

In some embodiments, the information promotion page is a commodity information page, a person information page, a product information page, or the like related to the mediator account.

Operation 511: Display, in the waiting space in response to a trigger operation for the return entry, a visual queue in which the at least one other visual element is queued according to a third queuing formation.

In conclusion, according to the method provided in this embodiment, a visual queue in which at least two accounts are queued is displayed in an online room. The at least two accounts include a first account and any another account other than the first account. Interaction information of interaction between the first account and a mediator account in the online room is displayed in response to an interaction operation, thereby providing a queuing function in the online room. Therefore, in a case that there are many viewer users, an offline scenario of queuing for interaction can be simulated, such as an enterprise annual meeting, a kick-off red packet giving meeting, or an idol signing session. In addition, for the first account, an interaction function of exclusively interacting with the mediator account is provided, to block interference of another account, improve interaction quality of interaction between each queued account and the mediator account, and avoid a waste of hardware resources supporting an online room function caused by low-quality interaction.

According to the method provided in this embodiment, multiple interaction functions are provided in the waiting space, so that in a queuing process, the first account may first interact with each another account in various forms.

According to the method provided in this embodiment, multiple interaction functions are provided in the interaction space, so that the first account and the mediator account can implement one-to-one exclusive interaction.

Different embodiments are used below for description with reference to specific scenarios.

For an embodiment in which a scenario of “giving a kick-off red packet” is simulated by using an online meeting:

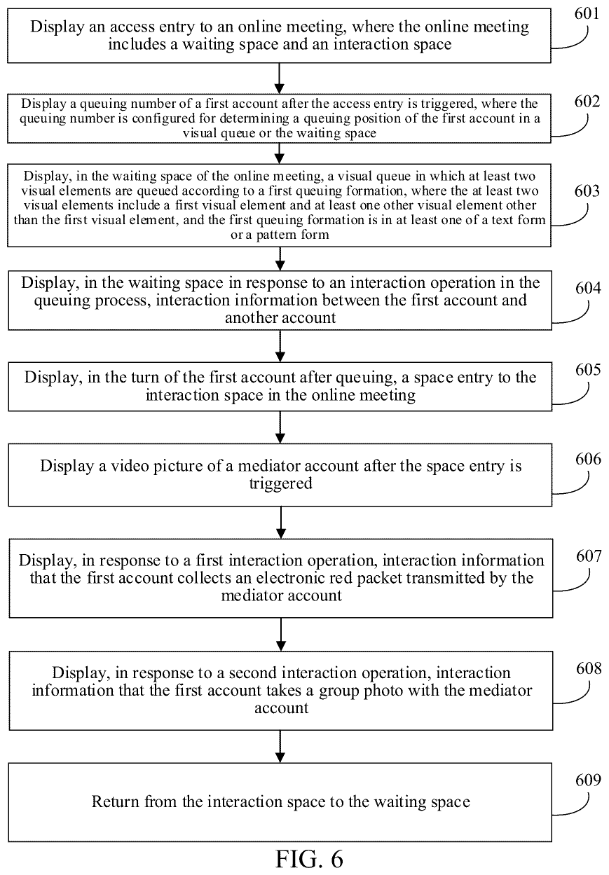

FIG. 6 shows a schematic interaction diagram of an online room interaction method according to some embodiments. The method may be performed by a computer device. A first account is logged into on the computer device. The method includes the following operations.

Operation 601: Display an access entry to an online meeting, where the online meeting includes a waiting space and an interaction space.

The online meeting is an online meeting in which at least two users are located.

The first account enters the online meeting through the access entry. The access entry includes: a graphic code, an invitation link, and the like.

The first account enters the online room through the access entry. The access entry includes: a graphic code, an invitation link, and the like. The access entry is pushed directionally, extracted randomly, or collected by performing a task.

In some embodiments, the online room includes: a waiting space and at least one interaction space. The waiting space is space waiting to perform an exclusive interaction with a mediator account. The interaction space is space in which the mediator account performs an exclusive interaction with the accounts. The interaction space is provided by the mediator account, or the interaction space corresponds to the mediator account. Each mediator account corresponds to one interaction space, and one interaction space corresponds to one or more mediator accounts. In some embodiments, the interaction spaces corresponding to the mediator accounts are different from each other, or at least one mediator account corresponding to each interaction control is different from each other.

Each account in a queued state is located in the waiting space. One or n accounts in the round of the first account after queuing are located in the interaction space of the mediator account. After the exclusive interaction ends, the first account may return from the interaction space of the mediator account to the waiting space.

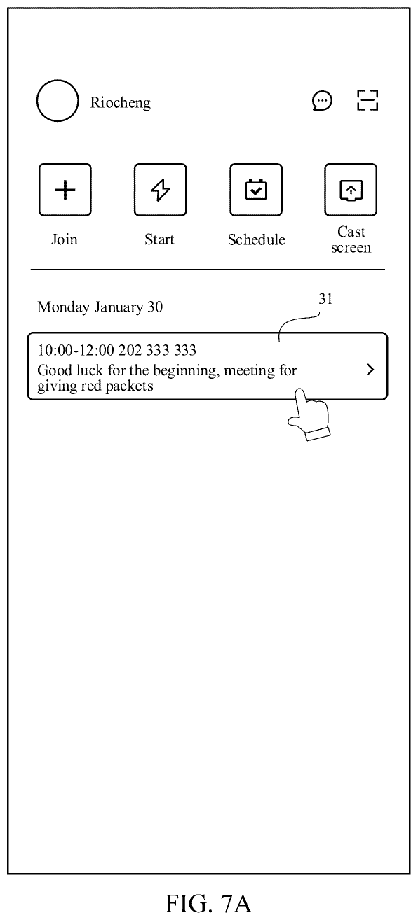

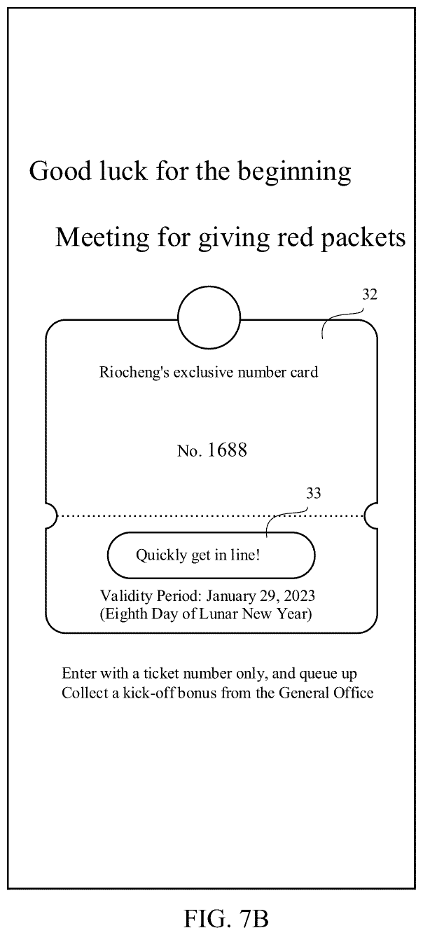

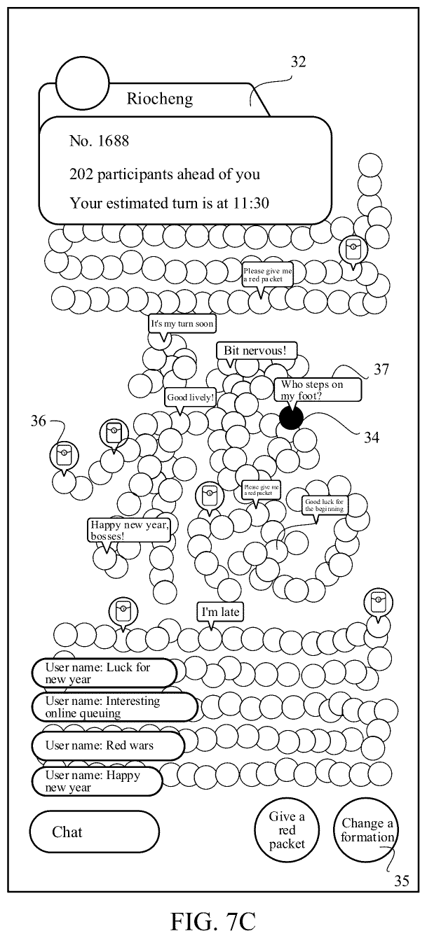

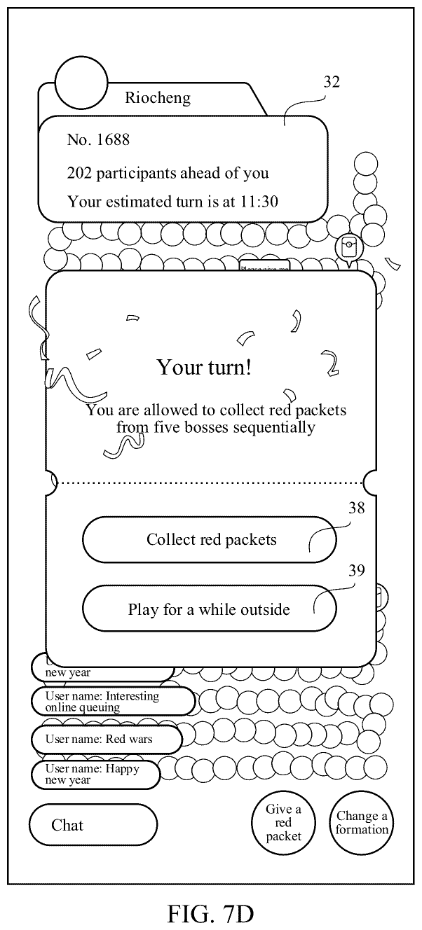

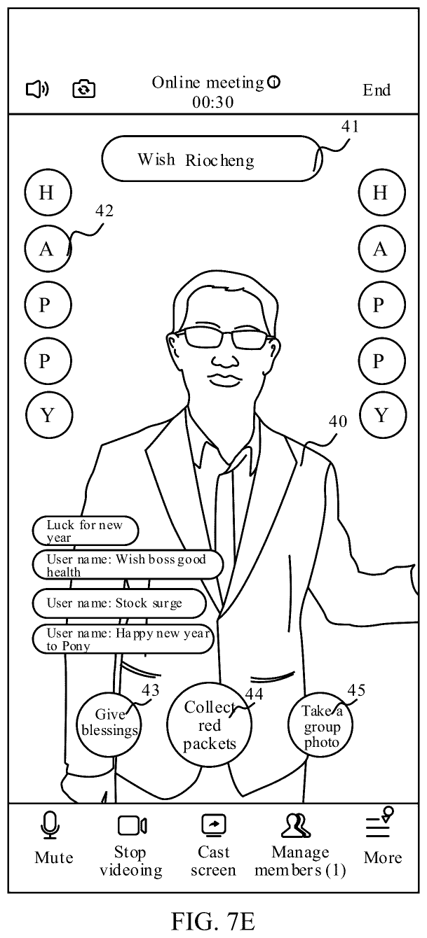

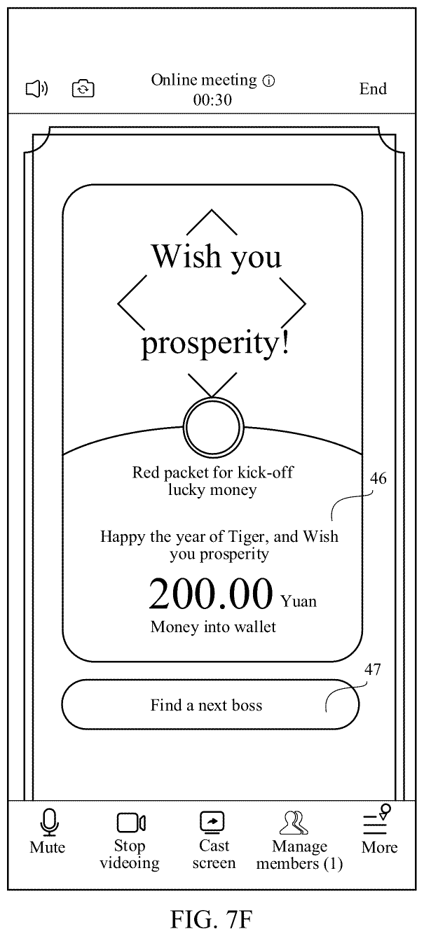

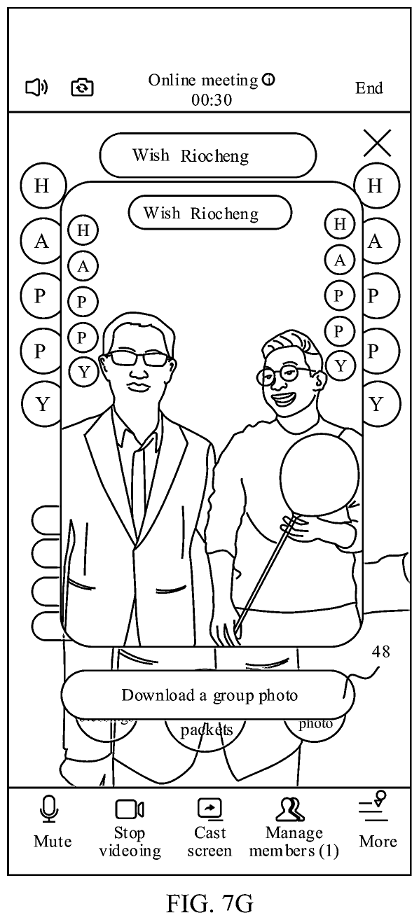

For example, as shown in FIG. 7A, after the first account starts an online meeting client, the online meeting client displays an access entry 31 of an online meeting. The access entry 31 displays:

Meeting time: 10:00-12:00, meeting number: 202333333.

Meeting name: Good luck for the beginning, meeting for giving red packets.

After the access entry 31 is clicked/tapped, the first account “Riocheng” enters an online meeting. The online meeting includes a waiting space and an interaction space. In this embodiment, an example in which the waiting space is referred to as an interaction hall is used.

Operation 602: Display a queuing number of a first account after the access entry is triggered, where the queuing number is configured for determining a queuing position of the first account in the visual queue or the waiting space.

In some embodiments, the queuing numbers of the accounts are generated according to a chronological order of triggering the access entry by the accounts, according to a chronological order of the accounts entering the online meeting, according to work numbers of the accounts in an organization, or according to random numbers extracted from the accounts. A mode of generating a queuing number of each account is not limited.

For example, as shown in FIG. 7B, after a user clicks/taps the access entry, an entry page of the interaction hall is displayed. At least one of the following pieces of information is displayed on the entry page of the interaction hall:

Meeting name: Good luck for the beginning, meeting for giving red packets.

An exclusive number card 32 of a first account corresponding to a nickname “Riocheng”, a queuing number of 1688, and an entry button 33 of the interaction hall. In some embodiments, the exclusive number card 32 further displays an avatar of the first account.

Operation 603: Display, in the waiting space of the online meeting, a visual queue in which at least two visual elements are queued according to a first queuing formation, where the at least two visual elements include a first visual element and at least one other visual element other than the first visual element, and the first queuing formation is in at least one of a text form or a pattern form.

In some embodiments, after the access entry is triggered, a queuing number of the first account and a space entry to the waiting space are displayed. When the user triggers the space entry to the interaction hall, the first account enters the interaction hall.

In some embodiments, after the access entry is triggered, the first account enters the interaction hall, and the queuing number of the first account is displayed in the interaction hall. The queuing number may be displayed all the time, or may be automatically canceled after being displayed for several seconds, or may be manually canceled by the user after being displayed.

In some embodiments, the queuing number of the first account is displayed, the queuing number of the first account is canceled after being displayed for several seconds, and the interaction hall is automatically entered.

The first account enters the waiting space of the online meeting, and a visual queue in which the first account and at least one other account are queued according to a queuing number is displayed. The first avatar corresponds to the first account. The at least one other avatar is in one-to-one correspondence with the at least one other account.

For example, as shown in FIG. 7C, after the entry button of the interaction hall is clicked/tapped, at least one of the following pieces of information is displayed on the page of the interaction hall:

An exclusive number card 1688 of the first account “Riocheng”, a quantity of queued persons ahead of the first account, and an estimated time for the first account in the turn of the first account after queuing.

A visual queue in which an avatar 34 of the first account “Riocheng” and an avatar of another account are queued according to patterns formed by Chinese characters that express blessings.

A real-time bullet screen formed by messages transmitted by at least one account in the waiting space, a message input box “Chat”, and a red packet giving button and a formation change button 37.

If the user clicks/taps the formation change button, the queuing formation of the visual queue may be changed. To be specific, in response to an array change operation, a visual queue in which the first avatar and at least one other avatar are queued according to a second queuing formation is displayed in the interaction hall.

In some embodiments, a plurality of queuing formations are pre-configured. In response to an array replacement operation triggered by the first account, a visual queue in which the first visual element and at least one other visual element are queued according to a second queuing formation is displayed in the waiting space. The second queuing formation is one of the plurality of queuing formations that is located behind the first queuing formation, or the second queuing formation is randomly selected from the plurality of queuing formations.

Operation 604: Display, in the waiting space in response to an interaction operation in the queuing process, interaction information between the first account and another account.

The waiting space provides multiple interaction functions between the first account and at least one other account. The interaction function includes at least one of a real-time interaction bullet screen between the first account and another account, collecting a virtual resource, entering an interaction emoji, connecting a microphone, and performing a group photo, a voice conversation, and a video conversation.

In some embodiments, in response to an operation of giving a first red packet, a collection entry to the first red packet given by the first account is displayed by using the first avatar as an anchor. The displaying by using the first avatar as an anchor may be understood as: displaying by using the first avatar as a reference position, or displaying by surrounding the first avatar.

In some embodiments, a collection entry to a second red packet given by a second account is displayed by using a second avatar as an anchor, where the second avatar belongs to the at least one other avatar, the second avatar corresponds to the second account, and the second account belongs to the at least one other account. In response to an operation of collecting the second red packet, a collection result of the first account for the second red packet is displayed. For example, as shown in FIG. 7C, a collection entry 36 of the second red packet given by the second account is displayed by using the second avatar as an anchor.

In some embodiments, in response to a messaging operation, a first message transmitted by the first account is displayed by using the first avatar as an anchor. For example, as shown in FIG. 7C, if the user transmits a message “Who steps on my foot” in a message input box “Chat”, a first message 37 transmitted by the first account is displayed by using the first avatar 34 as an anchor.

In some embodiments, in response to receiving a second message transmitted by a second account, the second message transmitted by the second account is displayed by using a second avatar as an anchor, where the second avatar belongs to the at least one other avatar, and the second avatar corresponds to the second account.

In some embodiments, in response to an emoji-entering operation, an emoji is displayed by using the first avatar as an anchor, or the emoji is displayed by using the first avatar as a carrier, or the emoji is displayed by using the waiting space as a carrier. The emoji is at least one of a text emoji, a picture emoji, an animated emoji, a dynamic emoji based on a three-dimensional virtual image, or an atmosphere emoji.

The displaying the emoji by using the first avatar as a carrier may be understood as: displaying, in a case that the first avatar is a two-dimensional virtual image, the emoji by using the two-dimensional virtual image; and displaying, in a case that the first avatar is a three-dimensional virtual image, the emoji by using the three-dimensional virtual image.

The displaying the emoji by using the waiting space as a carrier may be understood as: An emoji, for example, meteor shower falling, love, flower, birthday cake, or airplane, is displayed in the waiting space.

The foregoing interaction modes may be combined with each other or implemented separately. This is not limited in this embodiment.

Operation 605: Display, in the turn of the first account after queuing, the space entry to the interaction space in the online meeting.

The turn of the first account after queuing means the turn of the first account performing a one-to-one exclusive interaction with the mediator account according to the queuing sequence. In the turn of the first account after queuing, another account ranked ahead the first account has completely interacted with the mediator account.

In the turn of the first account after queuing, the space entry to the interaction space in the online room is displayed. Alternatively, the waiting space in the online room is switched to the space entry to the interaction space. Alternatively, the interaction hall of the online room is switched to the space entry to the interaction space.

For example, as shown in FIG. 7D, success information “Your turn!”, a button “Collect a red packet” 38, and a button “Play for a while outside” 39 are displayed in the interaction hall in a pop-up form.

The button “Collect a red packet” 38 is the space entry to the interaction space, and the button “Play for a while outside” 39 is a button for returning to the interaction hall.

Operation 606: Display a video picture of a mediator account after the space entry is triggered.

For example, referring to FIG. 7E, after the user clicks/taps the button 38 “Collect a red packet”, a user interface of the interaction space is displayed. An online video picture of a mediator account 40 is displayed. For example, the mediator account 40 is a company boss, who gives red packets and new year's greetings in a kick-off red packet giving meeting.

On the user interface of the interaction space, some decorative accessories are further displayed, for example, an accessory 41 “Wish Riocheng”, and an accessory 42 “Happy New Year, and best wishes”.

In some embodiments, at least one interaction control is displayed on the video picture of the interaction space. The interaction control is configured for providing at least one of interaction functions such as a real-time interaction bullet screen, collecting a red packet, entering an interaction emoji, connecting a microphone, and performing a group photo, a voice conversation, or a video conversation.

For example, referring to FIG. 7E, the video picture of the interaction space further displays a blessing giving button 43, a red packet collecting button 44, and a group photo taking button 45.

Operation 607: Display, in response to a first interaction operation, interaction information that the first account collects an electronic red packet transmitted by the mediator account.

For example, referring to FIG. 7F, in response to clicking/tapping the red packet collecting button 44, interaction information that the first account collects an electronic red packet given by the mediator account is displayed. A red packet cover 46 is displayed on the interaction information. The red packet cover 46 displays:

Red packet name: Red packet for kick-off red packet.

Blessings: Happy the year of Tiger, and Wish you prosperity.

Red packet amount: 200 yuan.

In some embodiments, the interaction information further displays a “Find a next boss” button 47. After the “Find a next boss” button 47 is clicked/tapped, an interaction space of a next mediator account is switched to, and interaction spaces of mediator accounts are independent of each other.

Operation 608: Display, in response to a second interaction operation, interaction information that the first account takes a group photo with the mediator account.

In some embodiments, an avatar, a half-length portrait, or a full-length portrait of the mediator account is displayed on the video picture of the interaction space. In some embodiments, an avatar, a half-length portrait, or a full-length portrait of the first account is further displayed on the video picture of the interaction space. These portraits, half-length portraits, or full-length portraits are captured by a camera in real time, and may be used as image materials during subsequent composite photographing.

In response to clicking/tapping the group photo taking button 45, interaction information that the first account takes a group photo with the mediator account is displayed.

For example, as shown in FIG. 7G, after the group photo is generated, a preview window of the group photo and a group photo downloading button 48 are displayed. In response to clicking/tapping the group photo downloading button 48, the user downloads the group photo to a local storage position.

In some embodiments, the video picture of the interaction space further displays a share button. In response to clicking/tapping the share button, the user shares the group photo on a social APP.

In some embodiments, the first online meeting client displays interaction information obtained after an image material of the first account and an image material of the mediator account are stitched according to a group photo template. The image materials are photographed in real time or user-defined and uploaded.

In some embodiments, before taking a group photo, the first account may upload the avatar, the half-length portrait, or the full-length portrait of the first account in advance. A server generates the image material of the first account in a mode such as image matting or beauty based on the photos uploaded by the first account.

In some embodiments, at least one of a first message, a mediator message, or a third message is displayed in a bullet-screen form in the interaction space. The first message is a message transmitted by the first account in the interaction space, the mediator message is a message transmitted by the mediator account in the interaction space, and the third message is a message transmitted by the at least one other account in the waiting space.

Operation 609: Return from the interaction space to the waiting space.

After the first account completes interaction with a current mediator, the first account may download, replay, and store interaction information between the first account and the current mediator.

In some embodiments, an exit button for returning to the waiting space is further displayed on the video picture of the interaction space. In response to clicking/tapping the exit button, the first account returns from the interaction space to the waiting space.

In conclusion, according to the method provided in this embodiment, a visual queue in which at least two accounts are queued is displayed in an online meeting. The at least two accounts include a first account and any another account other than the first account. Interaction information of interaction between the first account and a mediator account in the online meeting is displayed in response to an interaction operation, thereby providing a queuing function in the online meeting. Therefore, in a case that there are many viewer users, an offline scenario of queuing for interaction can be simulated, such as an enterprise annual meeting, a kick-off red packet giving meeting, or an idol signing session. In addition, for the first account, an interaction function of exclusively interacting with the mediator account is provided, to block interference of another account, improve interaction quality of interaction between each queued account and the mediator account, and avoid a waste of hardware resources supporting an online room function caused by low-quality interaction.

For an embodiment in which a scenario of “idol signing session” is simulated by using an online meeting:

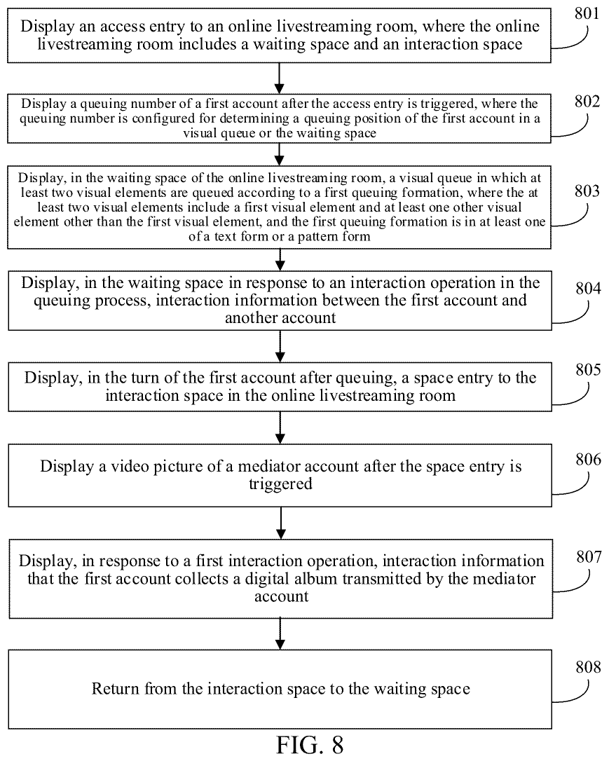

FIG. 8 shows a schematic interaction diagram of an online room interaction method according to some embodiments. The method may be performed by a computer device. A first account is logged into on the computer device. The method includes the following operations.

Operation 801: Display an access entry to an online livestreaming room, where the online livestreaming room includes a waiting space and an interaction space.

The online room is an online room in which at least two users are located. In some embodiments, the online room is an online livestreaming room or an online livestreaming room.

The first account enters the online room through the access entry. The access entry includes: a graphic code, an invitation link, and the like. The access entry is pushed directionally, extracted randomly, or collected by performing a task.

In some embodiments, the online room includes: a waiting space and at least one interaction space. The waiting space is space waiting to perform an exclusive interaction with a mediator account. The interaction space is space in which the mediator account performs an exclusive interaction with the accounts. The interaction space is provided by the mediator account, or the interaction space corresponds to the mediator account. Each mediator account corresponds to one interaction space, and one interaction space corresponds to one or more mediator accounts. In some embodiments, the interaction spaces corresponding to the mediator accounts are different from each other, or at least one mediator account corresponding to each interaction control is different from each other.

Each account in a queued state is located in the waiting space. One or n accounts in the round of the first account after queuing are located in the interaction space. After the exclusive interaction ends, each account may return from the interaction space to the waiting space.

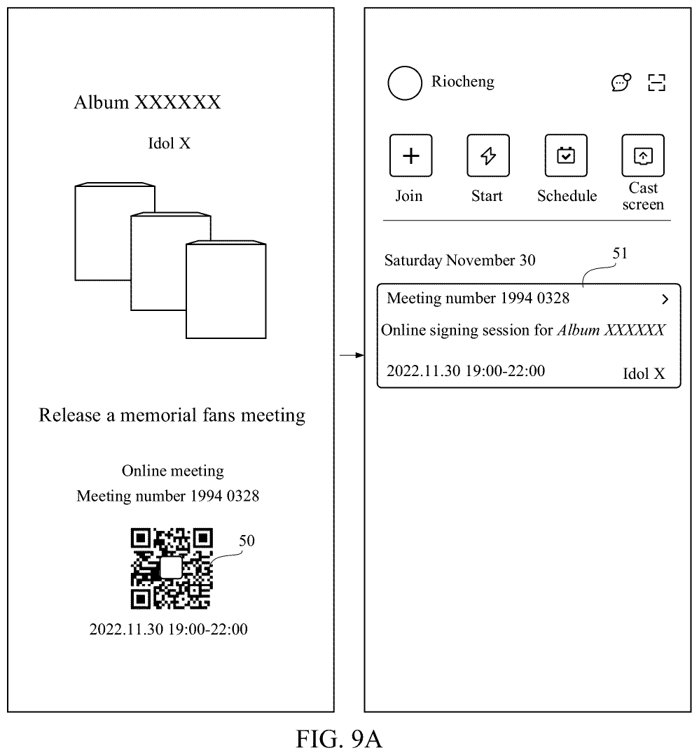

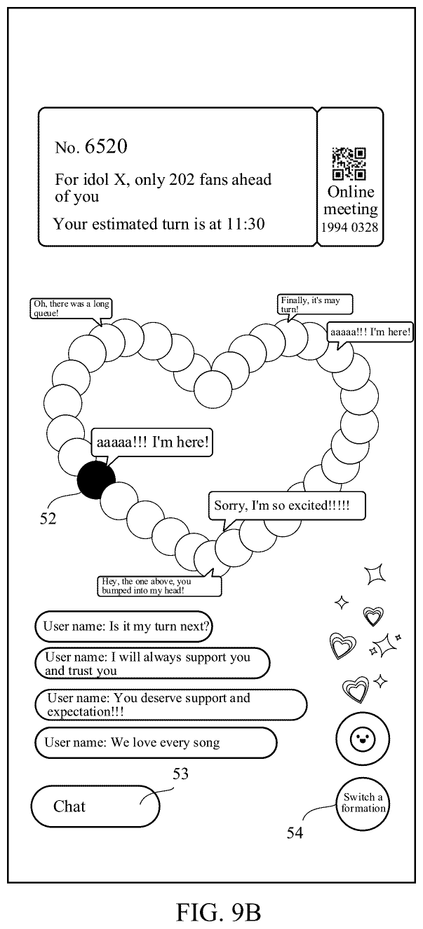

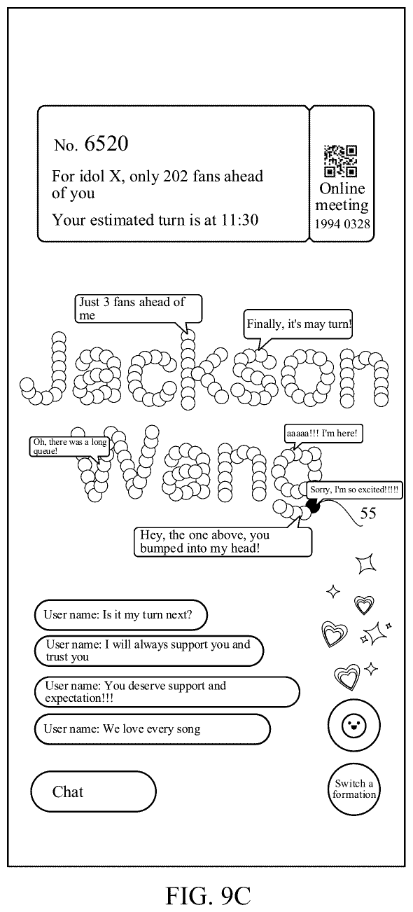

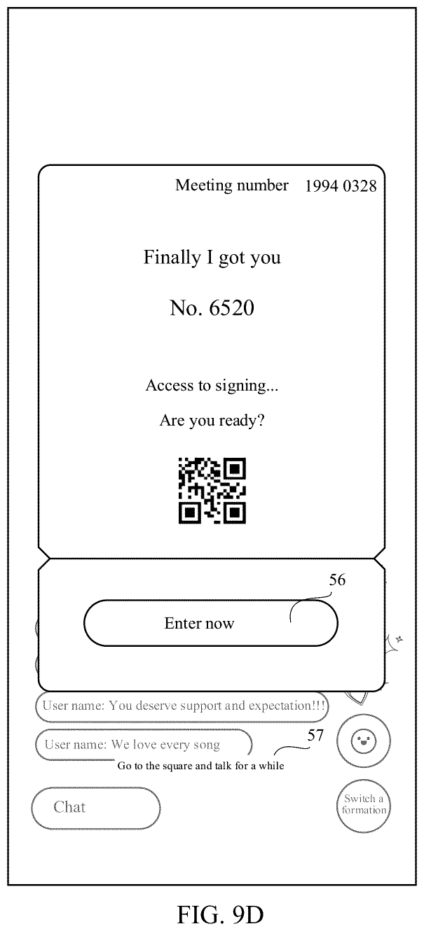

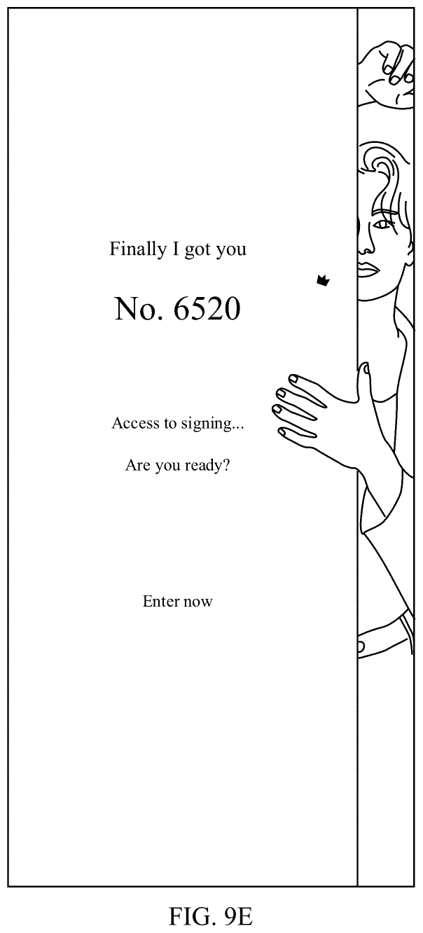

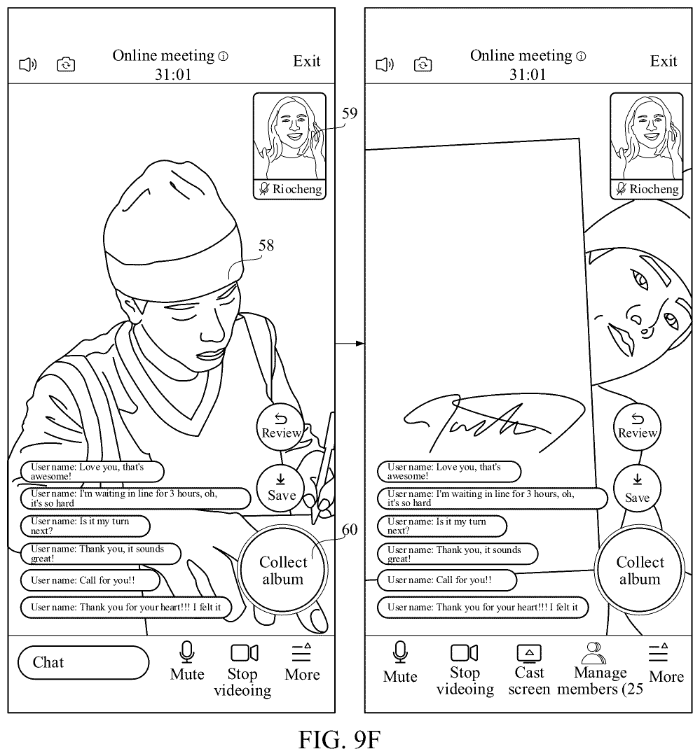

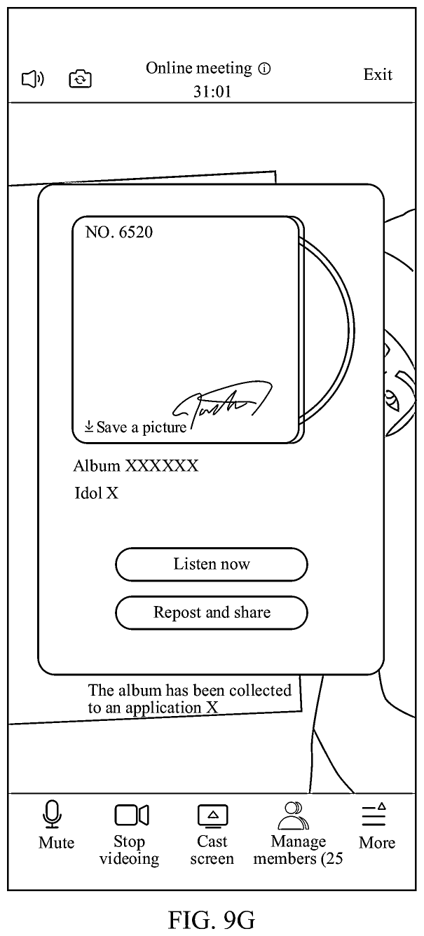

For example, as shown in FIG. 9A, after starting an online livestreaming room client, the first account may scan an access entry 50 in a form of a graphic code, and then the online livestreaming room client displays an access entry 51 of the online livestreaming room. The access entry 51 displays:

Meeting time: 19:00-22:00, meeting number: 1994 0328.

Meeting name: Online signing session for Album xxxxxx.

After the access entry 51 is clicked/tapped, the first account “Riocheng” enters

an online livestreaming room. The online livestreaming room includes a waiting space and an interaction space. In this embodiment, an example in which the waiting space is referred to as an interaction hall is used.

Operation 802: Display a queuing number of a first account after the access entry is triggered, where the queuing number is configured for determining a queuing position of the first account in the visual queue or the waiting space.

In some embodiments, the queuing numbers of the accounts are generated according to a chronological order of triggering the access entry by the accounts, according to a chronological order of the accounts entering the online livestreaming room, according to work numbers of the accounts in an organization, or according to random numbers extracted from the accounts. A mode of generating a queuing number of each account is not limited.

In some embodiments, after the access entry is triggered, the first account enters the interaction hall, and the queuing number of the first account is displayed in the interaction hall. The queuing number may be displayed all the time, or may be automatically canceled after being displayed for several seconds, or may be manually canceled by the user after being displayed.

For example, as shown in FIG. 9B, after a user clicks/taps the access entry, a user interface of the interaction hall is displayed. The interaction hall displays an exclusive number card 52 of the first account “Riocheng”, and a queuing number of 6520.

Operation 803: Display, in the waiting space of the online livestreaming room, a visual queue in which at least two visual elements are queued according to a first queuing formation, where the at least two visual elements include a first visual element and at least one other visual element other than the first visual element, and the first queuing formation is in at least one of a text form or a pattern form.

The interaction hall displays a visual queue in which the first account and at least one other account are queued according to a queuing number. The first avatar corresponds to the first account. The at least one other avatar is in one-to-one correspondence with the at least one other account.

For example, as shown in FIG. 9B, after the entry button of the interaction hall is clicked/tapped, at least one of the following pieces of information is displayed on the page of the interaction hall:

An exclusive number card 6520 of the first account “Riocheng”, a quantity “202” of queued persons ahead of the first account, and an estimated time “11:30” for the first account in the turn of the first account after queuing.

A visual queue in which an avatar 52 of the first account “Riocheng” and an avatar of another account are queued according to patterns formed by Chinese characters that express blessings.

A real-time bullet screen formed by messages transmitted by at least one account in the waiting space, a message input box “Chat” 53, and a formation change button 54.

In response to an array replacement operation triggered by the first account, a visual queue in which at least two visual elements and at least one other visual element are queued according to a second queuing formation is displayed in the waiting space. The second queuing formation is one of the plurality of queuing formations that is located behind the first queuing formation, or the second queuing formation is randomly selected from the plurality of queuing formations.

In FIG. 9B, an example in which the first queuing formation is a heart pattern is used for description. If the user clicks/taps the formation change button 54, the queuing formation of the visual queue may be changed into the second queuing formation.

For example, as shown in FIG. 9C, after the user clicks/taps the formation change button 54, the queuing formation is changed from a heart pattern to a text string formation 55.

Operation 804: Display, in the waiting space in response to an interaction operation in the queuing process, interaction information between the first account and another account.

The waiting space provides multiple interaction functions between the first account and at least one other account. The interaction function includes at least one of a real-time interaction bullet screen between the first account and another account, collecting a virtual resource, entering an interaction emoji, connecting a microphone, and performing a group photo, a voice conversation, and a video conversation.

In some embodiments, in response to an operation of giving a first red packet, a collection entry to the first red packet given by the first account is displayed by using the first avatar as an anchor. The displaying by using the first avatar as an anchor may be understood as: displaying by using the first avatar as a reference position, or displaying by surrounding the first avatar.

In some embodiments, a collection entry to a second red packet given by a second account is displayed by using a second avatar as an anchor, where the second avatar belongs to the at least one other avatar, the second avatar corresponds to the second account, and the second account belongs to the at least one other account. In response to an operation of collecting the second red packet, a collection result of the first account for the second red packet is displayed.

In some embodiments, in response to a messaging operation, a first message transmitted by the first account is displayed by using the first avatar as an anchor.

In some embodiments, in response to receiving a second message transmitted by a second account, the second message transmitted by the second account is displayed by using a second avatar as an anchor, where the second avatar belongs to the at least one other avatar, and the second avatar corresponds to the second account.

In some embodiments, in response to an emoji-entering operation, an emoji is displayed by using the first avatar as an anchor, or the emoji is displayed by using the first avatar as a carrier, or the emoji is displayed by using the waiting space as a carrier. The emoji is at least one of a text emoji, a picture emoji, an animated emoji, a dynamic emoji based on a three-dimensional virtual image, or an atmosphere emoji.

The displaying the emoji by using the first avatar as a carrier may be understood as: displaying, in a case that the first avatar is a two-dimensional virtual image, the emoji by using the two-dimensional virtual image; and displaying, in a case that the first avatar is a three-dimensional virtual image, the emoji by using the three-dimensional virtual image.

The displaying the emoji by using the waiting space as a carrier may be understood as: An emoji, for example, meteor shower falling, love, flower, birthday cake, or airplane, is displayed in the waiting space.

The foregoing interaction modes may be combined with each other or implemented separately. This is not limited in this embodiment.

For example, as shown in FIG. 9C, if the user transmits a message “Sorry, I'm so excited” in a message input box “Chat”, the first message “Sorry, I'm so excited” transmitted by the first account is displayed by using the first avatar 52 as an anchor.

Operation 805: In the turn of the first account after queuing, a space entry to the interaction space in the online livestreaming room is displayed.

The turn of the first account after queuing means the turn of the first account performing a one-to-one exclusive interaction with the mediator account according to the queuing sequence. In the turn of the first account after queuing, another account ranked ahead the first account has completely interacted with the mediator account.

In the turn of the first account after queuing, the space entry to the interaction space in the online room is displayed. Alternatively, the waiting space in the online room is switched to the space entry to the interaction space. Alternatively, the interaction hall of the online room is switched to the space entry to the interaction space.

For example, as shown in FIG. 9D, success information “Finally got you”, a button “Enter now” 56, and a button “Go to the square and talk for a while” 57 are displayed in the interaction hall in a pop-up form.

The button “Enter now” 56 is the space entry to the interaction space, and the button “Go to the square and talk for a while” 57 is a button for returning to the interaction hall.

Operation 806: Display a video picture of a mediator account after the space entry is triggered.

After the user clicks/taps the button “Enter now” 56, for example, referring to FIG. 9E, an entry animation of the interaction space is displayed. The entry animation is opened from right to left, and a video picture of a mediator account 58 is gradually displayed.

For example, as shown in FIG. 9F, an online video picture of the mediator account 58 and an online video picture of the first account 59 are displayed. For example, the mediator account 58 is an idol x, who gives a digital album to fans at an album signing session.

In some embodiments, at least one interaction control is displayed on the video picture of the interaction space. The interaction control is configured for providing at least one of interaction functions such as a real-time interaction bullet screen, collecting a red packet, entering an interaction emoji, connecting a microphone, and performing a group photo, a voice conversation, or a video conversation.

For example, referring to FIG. 9F, the video picture of the interaction space further displays an album collecting button 60.

Operation 807: Display, in response to a first interaction operation, interaction information that the first account collects a digital album transmitted by the mediator account.

For example, referring to FIG. 9G, in response to clicking/tapping the album collecting button 60, interaction information that the first account collects a digital album given by the mediator account is displayed. An album cover is displayed on the interaction information, and an album name, an idol name, an album saving button, a listen-now button, a repost-and-share button, and the like are displayed on the album cover.

Operation 808: Return from the interaction space to the waiting space.

After the first account completes interaction with a current mediator, the first account may download, replay, and store interaction information between the first account and the current mediator.

In some embodiments, an exit button for returning to the waiting space is further displayed on the video picture of the interaction space. In response to clicking/tapping the exit button, the first account returns from the interaction space to the waiting space.

In conclusion, according to the method provided in this embodiment, a visual queue in which at least two accounts are queued is displayed in an online meeting. The at least two accounts include a first account and any another account other than the first account. Interaction information of interaction between the first account and a mediator account in the online meeting is displayed in response to an interaction operation, thereby providing a queuing function in the online meeting. Therefore, in a case that there are many viewer users, an offline scenario of queuing for interaction can be simulated, such as an enterprise annual meeting, a kick-off red packet giving meeting, or an idol signing session. In addition, for the first account, an interaction function of exclusively interacting with the mediator account is provided, to block interference of another account, improve interaction quality of interaction between each queued account and the mediator account, and avoid a waste of hardware resources supporting an online room function caused by low-quality interaction.

During implementation, the foregoing solution includes: a meeting creation procedure and a meeting holding procedure.

### Meeting Creation Procedure

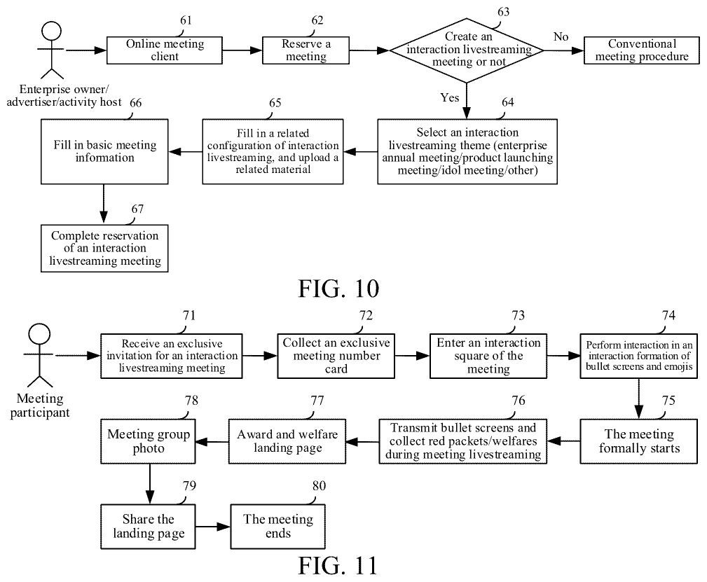

FIG. 10 shows a schematic flowchart of a meeting creation method according to some embodiments. The method includes the following operations.

Operation 61: Start an online meeting client.

An enterprise owner/advertiser/activity host starts an online meeting client.

Operation 62: Schedule a meeting.

The enterprise owner/advertiser/activity host may create a new meeting or schedule a meeting.

Operation 63: Create an interaction livestreaming meeting or not.

If yes, operation 64 is entered. If no, a meeting is created, and a meeting procedure is performed.

Operation 64: Select an interaction livestreaming theme.

The interaction livestreaming theme includes: at least one of an enterprise annual meeting, a product launching meeting, an idol meeting, or another activity.

Operation 65: Fill in a related configuration of interaction livestreaming, and upload a related material.

The related configuration of the interaction livestreaming includes at least one of the following:
Maximum interaction duration between each account and a mediator account.
Queuing formation of a visual queue.
Mode of generating a queuing number.
Giving configuration of an electronic red packet.
Transmitting configuration of a digital album.

The related material of the interaction livestreaming includes at least one of the following:
Meeting background image.
Meeting atmosphere accessory.
Mode of generating a queuing number.
Material related to a user-defined pattern or text of a queuing formation of a visual queue.

Operation 66: Fill in basic meeting information.

The basic meeting information includes at least one of the following:
Meeting theme.
Meeting time.
Mediator account.
Viewer account.
Entry permission condition.

Operation 67: Complete scheduling of an interaction livestreaming meeting.

To be specific, when creating a new meeting, the enterprise owner/advertiser/activity host supports selecting an interaction livestreaming meeting. The interaction livestreaming meeting supports several preset theme templates, including an enterprise annual meeting/a product launching meeting/an idol meeting, and the like.

After the meeting subject template is determined, related materials such as an atmosphere image/an accessory/a welfare/a red packet may be uploaded according to the corresponding template, related information such as a queuing formation (a user-defined graph may be selected) in an interaction hall, and drawing rules (types/content/quantities) for welfares and red packets are configured, and a meeting time and range are determined. After related settings are completed, the interaction livestreaming meeting is successfully created.

### Meeting Holding Procedure

FIG. 11 shows a schematic flowchart of a meeting creation method according to some embodiments. The method includes the following operations.

Operation 71: Receive an exclusive invitation for an interaction livestreaming meeting.

Operation 72: Collect an exclusive meeting number card.

A participant may view an interaction livestreaming meeting invitation in a meeting list and an invitation, present a corresponding meeting theme and information, and collect a current meeting exclusive number card. An interaction hall of the meeting is opened according to a meeting configuration time before the meeting starts, and the participant may enter the interaction hall in advance.

Operation 73: Enter an interaction square of the meeting.

Operation 74: Perform interaction in an interaction formation of bullet screens and emojis.

The interaction hall provides bullet screen chat and signing wall capabilities. The signing wall supports participant avatars to form a formation according to a configured graphic form. The formation supports a preset template and uploads a user-defined formation during creation. The participant may switch between different forms by using a formation change button.

Operation 75: The meeting formally starts.

Operation 76: Transmit bullet screens and collect red packets/welfares during meeting livestreaming.

When a start time of the meeting arrives, an exclusive number card and a prompt for entering a meeting are presented, and an animation or a video for entering a meeting is played. The formal meeting is a livestreaming meeting, supporting a function and a bullet screen capability. A capability such as collecting a red packet, giving best wishes, or collecting a welfare may be presented according to the meeting configuration.

Operation 77: Award and welfare landing page.

Operation 78: Meeting group photo.

A corresponding landing page link is opened, and a group photo capability is provided according to the meeting configuration. A clear photo including a human face is uploaded through a camera or an album, and the human face is recognized by a background. A corresponding group photo is generated according to a group photo template during creation. The group photo supports downloading and sharing.

Operation 79: Share the landing page.

Operation 80: The meeting ends.

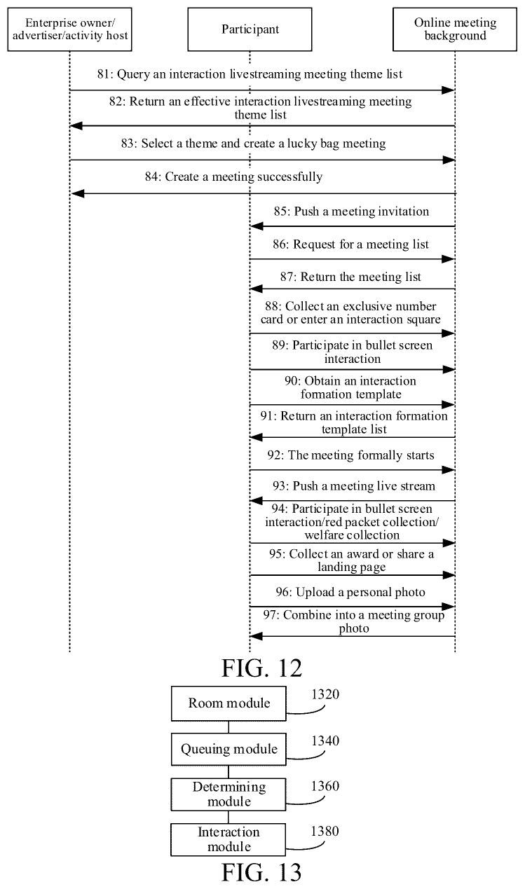

FIG. 12 shows a flowchart of an online interaction method according to some embodiments. The method includes the following operations.

Operation 81: Query an interaction livestreaming meeting theme list.

An enterprise owner/advertiser/activity host transmits a request for querying an interaction livestreaming meeting theme list to an online background.

Operation 82: Return an effective interaction livestreaming meeting theme list.

The online background returns an effective interaction livestreaming meeting theme list to the enterprise owner/advertiser/activity host.

Operation 83: Select a theme and create a lucky bag meeting.

The enterprise owner/advertiser/activity host selects a theme and creates a lucky bag meeting, and transmits the information to the online background.

Operation 84: Create a meeting successfully.

The online background transmits a message indicating that the meeting is successfully created to the enterprise owner/advertiser/activity host.

Operation 85: Push a meeting invitation.

The online background pushes a meeting invitation to a participant.

Operation 86: Request for a meeting list.

The participant requests for a meeting list from the online background.

Operation 87: Return the meeting list.

The online background returns the meeting list to the participant.

Operation 88: Collect an exclusive number card or enter an interaction square.

The participant collects an exclusive number card or enters an interaction square, and transmits the information to the online background.

Operation 89: Participate in bullet screen interaction.

The participant participates in the bullet screen interaction, and transmits the information to the online background.

Operation 90: Obtain an interaction formation template.

The participant transmits a request for obtaining an interaction formation template to the online background.

Operation 91: Return an interaction formation template list.

The online background returns an interaction formation template list to the participant.

Operation 92: The meeting formally starts.

The participant transmits information about formal beginning of the meeting to the online background.

Operation 93: Push a meeting live stream.

The online background pushes a meeting live stream to the participant.

Operation 94: Participate in bullet screen interaction/red packet collection/welfare collection.

The participant participates in the bullet screen interaction/red packet collection/welfare collection, and transmits the information to the online background.

Operation 95: Collect an award or share a landing page.

The participant collects an award or shares a landing page, and transmits the information to the online background.

Operation 96: Upload a personal photo.

The participant uploads a personal photo, and transmits the information to the online background.

Operation 97: Combine into a meeting group photo.

The online background combines into a meeting group photo, and transmits the information to the participant.

FIG. 13 shows a block diagram of an online interaction apparatus according to some embodiments. The apparatus includes:
a room module 1320, configured to display an access entry to an online room;
a queuing module 1340, configured to display, after the access entry is

triggered, a visual queue in which at least two accounts are queued, where the at least two accounts include the first account and any another account other than the first account;
a display module 1360, configured to display, in the turn of the first account

after queuing, a video picture of a mediator account in the online room; and
an interaction module 1380, configured to display, in response to an interaction operation, interaction information of interaction between the first account and the mediator account in the online room.

In some embodiments, the queuing module 1340 is configured to display, in a waiting space of the online room after the access entry is triggered, a visual queue in which at least two visual elements are queued, where the at least two visual elements include a first visual element and at least one other visual element other than the first visual element.

The waiting space is space in which an account in a queued state and/or an account completing interaction is located. The first visual element corresponds to the first account. The at least one other visual element is in one-to-one correspondence with the at least one other account.

In some embodiments, the queuing module 1340 is configured to display, in a waiting space of the online room after the access entry is triggered, a visual queue in which at least two visual elements are queued according to a first queuing formation. The at least two visual elements include a first visual element and at least one other visual element other than the first visual element.

The first queuing formation is in at least one of a text form or a pattern form.

In some embodiments, the apparatus further includes:

the queuing module 1340, configured to display, in the waiting space in response to an array replacement operation, a visual queue in which at least two visual elements are queued according to a second queuing formation, where the at least two visual elements include a first visual element and at least one other visual element other than the first visual element.

The first queuing formation is different from the second queuing formation.

In some embodiments, the queuing module 1340 is configured to display, in the waiting space, interaction information between the first account and the at least one account.

In some embodiments, the queuing module 1340 is configured to display, in response to an operation of giving a first virtual resource, a collection entry to the first virtual resource given by the first account by using the first visual element as an anchor.

In some embodiments, the queuing module 1340 is configured to: display, by using a second visual element as an anchor, a collection entry to a second virtual resource given by a second account, where the second visual element belongs to the at least one other visual element, and the second visual element corresponds to the second account; and display, in response to an operation of collecting the second virtual resource, a collection result of the first account for the second virtual resource.

In some embodiments, the queuing module 1340 is configured to: display, in response to a messaging operation by using the first visual element as an anchor, a first message transmitted by the first account; and/or, display, in response to receiving a second message transmitted by a second account, the second message transmitted by the second account by using a second visual element as an anchor, where the second visual element belongs to the at least one other visual element, and the second visual element corresponds to the second account.

In some embodiments, the queuing module 1340 is configured to display, in response to an emoji-entering operation, an emoji by using the first visual element as an anchor, or display the emoji by using the first visual element as a carrier.

In some embodiments, the queuing module 1340 is configured to display a queuing number of the first account, where the queuing number is configured for determining a queuing position of the first account in the visual queue.

In some embodiments, the display module 1360 is configured to: enter, in the turn of the first account after queuing, an interaction space of the mediator account from the waiting space; and display a video picture of the mediator account in the interaction space.

In some embodiments, the display module 1360 is configured to display at least one of a first message, a mediator message, or a third message in a bullet-screen form in the interaction space.

The first message is a message transmitted by the first account in the interaction space, the mediator message is a message transmitted by the mediator account in the interaction space, and the third message is a message transmitted by the at least one other account in the waiting space.

In some embodiments, the interaction module 1380 is configured to display, in response to a first interaction operation, interaction information that the first account collects a virtual resource transmitted by the mediator account.

The virtual resource includes at least one of an electronic red packet, an audio/video, a digital collection, a bonus point, or a coupon.

In some embodiments, the interaction module 1380 is configured to display, in response to a second interaction operation, interaction information that the first account takes a group photo with the mediator account.

In some embodiments, the interaction module 1380 is configured to display, in response to a second interaction operation, a group photo obtained after an image material of the first account and an image material of the mediator account are stitched according to a group photo template.

The image materials are photographed in real time or user-defined and uploaded.

In some embodiments, there are at least two mediator accounts. The interaction module 1380 is configured to display, in response to a mediator switching operation, a video picture of a next mediator account in the online room.

In some embodiments, the interaction module 1380 is configured to: display an information promotion page of the mediator account in a case that the interaction ends, where a return entry to the waiting space is displayed on the information promotion page. display, in the waiting space in response to a trigger operation for the return entry, a visual queue in which the at least one other visual element is queued according to a third queuing formation.

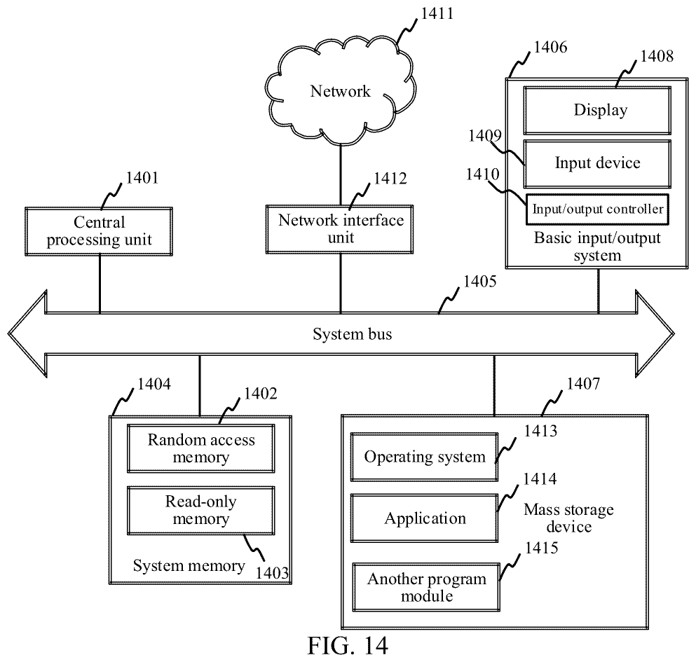

FIG. 14 is a schematic structural diagram of a computer device according to an exemplary embodiment. The computer device 1400 includes a central processing unit (CPU) 1401, a system memory 1404 including a random access memory (RAM) 1402 and a read-only memory (ROM) 1403, and a system bus 1405 connecting the system memory 1404 and the CPU 1401. The computer device 1400 further includes a input/output (I/O) system 1406 assisting in information transmission between components in the computer device, and a mass storage device 1407 configured to store an operating system 1413, an application 1414, and another program module 1415.

The I/O system 1406 includes a display 1408 configured to display information and an input device 1409 such as a mouse or a keyboard for inputting information by a user. The display 1408 and the input device 1409 are both connected to the CPU 1401 by using an I/O controller 1410 connected to the system bus 1405. The I/O system 1406 may further include the I/O controller 1410 to receive and process inputs from a plurality of other devices such as a keyboard, a mouse, or an electronic stylus. Similarly, the I/O controller 1410 further provides an output to a display screen, a printer, or another type of output device.

The mass storage device 1407 is connected to the CPU 1401 through a mass storage controller (not shown) connected to the system bus 1405. The mass storage device 1407 and a computer device-readable medium associated therewith provide non-volatile storage to the computer device 1400. In other words, the mass storage device 1407 may include a computer device-readable medium (not shown) such as a hard disk or a compact disc read-only memory (CD-ROM) drive.

Without loss of generality, the computer device-readable medium may include a computer device storage medium and a communication medium. The computer device storage medium includes volatile and non-volatile media, and removable and non-removable media implemented by using any method or technology used for storing information such as computer device-readable instructions, data structures, program modules, or other data. The computer device storage medium includes a RAM, a ROM, an erasable programmable ROM (EPROM), an electrically erasable programmable ROM (EEPROM), a flash memory or another solid-state memory technology, a CD-ROM, a digital versatile disc (DVD) or another optical memory, a tape cartridge, a magnetic cassette, a magnetic disk memory, or another magnetic storage device. Certainly, a person skilled in the art may learn that the computer device storage medium is not limited to the foregoing several types. The system memory 1404 and the mass storage device 1407 may be collectively referred to as a memory.

According to some embodiments, the computer device 1400 may be further connected, through a network such as the Internet, to a remote computer device on the network and run. To be specific, the computer device 1400 may be connected to a network 1411 through a network interface unit 1412 connected to the system bus 1405, or may be connected to another type of network or a remote computer device system (not shown) through a network interface unit 1412.

The memory further includes one or more programs. The one or more programs are stored in the memory. The CPU 1401 implements all or part of the operations of the foregoing knowledge graph-based entity edge creating method by executing the one or more programs. Some embodiments further provides a computer-readable storage medium. The storage medium has at least one instruction, at least one program, a code set, or an instruction set stored therein. The at least one instruction, the at least one program, the code set, or the instruction set is loaded and executed by a processor to implement the online interaction method provided in the foregoing method embodiments.

Some embodiments provide a computer program product. The computer program product includes a computer-readable instruction. The computer-readable instruction is stored in a computer-readable storage medium. A processor of a computer device reads the computer-readable instruction from the computer-readable storage medium. The processor executes the computer-readable instruction to cause the computer device to perform the online interaction method provided in the foregoing embodiments.

The sequence numbers of some embodiments are merely for description purpose but do not imply the preference among the embodiments.

According to some embodiments, each module or unit may exist respectively or be combined into one or more units. Some units may be further split into multiple smaller function subunits, thereby implementing the same operations without affecting the technical effects of some embodiments. The units are divided based on logical functions. In actual applications, a function of one unit may be realized by multiple units, or functions of multiple units may be realized by one unit. In some embodiments, the apparatus may further include other units. These functions may also be realized cooperatively by the other units, and may be realized cooperatively by multiple units.

A person skilled in the art would understand that these “modules” could be implemented by hardware logic, a processor or processors executing computer software code, or a combination of both. The “modules” may also be implemented in software stored in a memory of a computer or a non-transitory computer-readable medium, where the instructions of each module are executable by a processor to thereby cause the processor to perform the respective operations of the corresponding module

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. An online interaction method, performed by a computer device, the method comprising:
displaying an access entry to an online room;
displaying, based on the access entry being triggered, a visual queue comprising a first account and at least one other account;
displaying, based on a turn of the first account in a queue, a video picture of a mediator account in the online room; and
displaying, based on an first interaction operation, interaction information of interaction between the first account and the mediator account in the online room.

2. The method according to claim 1, further comprising:
displaying, in a waiting space of the online room and based on the access entry being triggered, a visual queue comprising a first visual element and at least one other visual element,
wherein the waiting space comprises space for at least one of an account in a queued state, or an account that has completed interaction, and
wherein the first visual element corresponds to the first account, and the at least one other visual element corresponds to the at least one other account.

3. The method according to claim 2, further comprising:
displaying, in the waiting space of the online room and based on the access entry being triggered, a visual queue in which at least two visual elements are queued according to a first queuing formation,
wherein the first queuing formation is in at least one of a text form or a pattern form.

4. The method according to claim 3, further comprising:
displaying, in the waiting space and based on an array replacement operation, a visual queue in which at least two visual elements are queued according to a second queuing formation, wherein the second queuing formation is different from the first queuing formation.

5. The method according to claim 2, further comprising:
displaying, in the waiting space, interaction information between the first account and the at least one account.

6. The method according to claim 5, further comprising:
displaying, based on an operation of giving a first virtual resource, a collection entry to the first virtual resource given by the first account, with the first visual element as an anchor.

7. The method according to claim 5, further comprising:
displaying, with a second visual element as an anchor, a collection entry to a second virtual resource given by a second account, wherein the second visual element belongs to at least one other visual element, and corresponds to the second account; and
displaying, based on an operation of collecting the second virtual resource, a collection result of the first account for the second virtual resource.

8. The method according to claim 5, further comprising:
displaying at least one of:
a first message transmitted by the first account based on a messaging operation, with the first visual element as an anchor,
a second message transmitted by a second account based on a messaging operation by the second account, with a second visual element as an anchor,
or a combination thereof,
wherein the second visual element belongs to the at least one other visual element, and corresponds to the second account.

9. The method according to claim 5, further comprising:
displaying, based on an emoji-entering operation, an emoji with the first visual element as an anchor; or
displaying the emoji with the first visual element as a carrier.

10. The method according to claim 1, further comprising:
displaying a queuing number of the first account, wherein the queuing number determines a queuing position of the first account in the visual queue.

11. The method according to claim 2, further comprising:
entering, in the turn of the first account in a queue, an interaction space of the mediator account from the waiting space; and
displaying a video picture of the mediator account in the interaction space.

12. The method according to claim 11, further comprising:
displaying at least one message in a bullet-screen form in the interaction space,
wherein at least one message comprises at least one of:
a first message transmitted by the first account in the interaction space,
a mediator message transmitted by the mediator account in the interaction space, or
a third message transmitted by at least one other account in the waiting space.

13. The method according to claim 1, further comprising:
displaying, based on a first interaction operation, interaction information of the first account collecting a virtual resource that is transmitted by the mediator account,
wherein the virtual resource comprises at least one of an electronic red packet, an audio, a video, a digital collection, a bonus point, or a coupon.

14. The method according to claim 1, further comprising:
displaying, based on a second interaction operation, interaction information of the first account taking a group photo with the mediator account.

15. The method according to claim 14, further comprising:
displaying, based on a second interaction operation, a group photo based on combining an image material of the first account and an image material of the mediator account according to a group photo template,
wherein the image materials are captured in real time, or user-defined and uploaded.

16. The method according to claim 1, wherein there are at least two mediator accounts, the method further comprising:
displaying, based on a mediator switching operation, a video picture of a next mediator account in the online room.

17. An online interaction apparatus, comprising:
at least one memory configured to store program code; and
at least one processor configured to read the program code and operate as instructed by the program code, the program code comprising:
room code configured to cause at least one of the at least one processor to display an access entry to an online room;
queuing code configured to cause at least one of the at least one processor to display, based on the access entry being triggered, a visual queue comprising a first account and at least one other account;
displaying code configured to cause at least one of the at least one processor to display, based on a turn of the first account in a queue, a video picture of a mediator account in the online room; and
interaction code configured to cause at least one of the at least one processor to display, based on an interaction operation, interaction information of interaction between the first account and the mediator account in the online room.

18. The apparatus according to claim 17, wherein the program code is further configured to cause at least one of the at least one processor to:
display, in a waiting space of the online room and based on the access entry being triggered, a visual queue comprising a first visual element and at least one other visual element,
wherein the waiting space comprises space for at least one of an account in a queued state, or an account that has completed interaction,
wherein the first visual element corresponds to the first account, and the at least one other visual element corresponds to the at least one other account.

19. The apparatus according to claim 18, wherein the program code is further configured to cause at least one of the at least one processor to:
display, in the waiting space of the online room and based on the access entry being triggered, a visual queue in which at least two visual elements are queued according to a first queuing formation,
wherein the first queuing formation is in at least one of a text form or a pattern form.

20. A non-transitory computer-readable storage medium, storing computer code which, when executed by at least one processor, causes the at least one processor to at least:
display an access entry to an online room;
display, based on the access entry being triggered, a visual queue comprising a first account and at least one other account;
display, based on a turn of the first account in a queue, a video picture of a mediator account in the online room; and
display, based on an interaction operation, interaction information of interaction between the first account and the mediator account in the online room.
